(19) United States
(12) Patent Application Publication
(10) Pub. No.: US 2009/0296540 A1
(43) Pub. Date: Dec. 3, 2009

(54) MEDICAL DISC PUBLISHER

(75) Inventors: Alan J. Gilbert, Hudson, OH (US); Richard M. Edwards, Akron, OH (US); Stephen N. Mucher, Yellow Springs, OH (US); Jeffrey L. Spencer, Cuyahoga Falls, OH (US); Gary W. Keefe, Brecksville, OH (US); Christopher M. Tainer, Strongsville, OH (US); Garvin Seto, Highland Heights, OH (US); Bret E. Orsburn, Kent, OH (US); Peter O. Botten, Lakewood, OH (US); Heidi Shaffer, Kent, OH (US)

Correspondence Address: PEARNE & GORDON LLP, 1801 EAST 9TH STREET, SUITE 1200, CLEVELAND, OH, 44114-3108, US

(73) Assignee: Codonics, Inc., Middleburg Heights, OH (US)

(21) Appl. No.: 12/324,830

(22) Filed: Nov. 26, 2008

Related U.S. Application Data
(60) Provisional application No. 60/990,170, filed on Nov. 26, 2007.

(51) Int. Cl. G11B 7/085; G06F 15/16; G06F 3/00; G06F 12/08; G06F 9/46; G06F 12/02

(52) U.S. Cl. 369/30.23; 709/219; 710/6; 709/247; 711/126; 718/102; 711/115; 711/171; 711/E12.019; 711/E12.002; G9B/7.042

(57) ABSTRACT

A method and apparatus for storing on a portable computer-readable medium, a study comprising at least one medical output produced by a medical modality and formatted in a standard medical format used by specialized computers configured for viewing outputs produced by medical modalities, and optionally labeling the portable computer-readable medium. The method includes receiving a transmission comprising the medical output that is formatted according to the standard medical format, at least temporarily storing the medical output as it is received in a buffer memory to be subsequently stored onto the portable computer-readable medium, and storing the medical output from the buffer memory onto the portable computer-readable medium.

### CROSS-REFERENCE TO RELATED APPLICATIONS

This application claims the benefit of U.S. Provisional Patent Application No. 60/990,170, filed Nov. 26, 2007, the entirety of which is incorporated herein by reference.

### BACKGROUND OF THE INVENTION

1. Field of the Invention

This application relates generally to a method and apparatus for storing electronic data onto a portable computer-readable medium, and more specifically to a computer-readable media publisher and method for rapidly receiving, arranging and electronically storing output from a medical modality onto optical and/or other portable computer-readable media.

2. Description of Related Art

It is known to utilize medical images in the diagnosis of disease. Commonly, a patient will describe current symptoms to a primary physician or provider. The primary physician or provider may order an image-based test to diagnose or assess the patient's condition. Often, the image-based test is conducted within the same medical facility, but apart from where the patient meets with the primary physician or provider. The images are then transmitted across a network so that they can be viewed by the primary physician or provider. Of course, the issues described below are equally as relevant when the image-based testing must be conducted at a separate facility apart from the location of the primary physician or provider.

It is known to transfer medical images resulting from an image-based test to a portable computer-readable medium such as a compact disc, or CD or a digital video disc, or DVD. The portable computer-readable medium may be given to the patient so that a second physician or provider can easily view the images and documentation provided thereon. Typically, the second physician or provider specializes in the relevant area of medicine or science corresponding to the patient's condition or disease. Often, the primary physician and the second physician are located at separate facilities, further increasing the need for the images to be recorded onto the portable computer-readable medium. The images included on the portable computer-readable medium may be essential to the second physician being able to correctly and adequately diagnose or interpret the patient's condition. The portable computer-readable medium may instead be delivered to a referring physician, lawyers engaged in a legal proceeding, the patient himself for home viewing, and any other recipient.

It is known that the transfer of data, such as medical images and related studies or other information, onto a portable computer-readable media comprises several distinct operations. Conventionally, these distinct operations are performed in series, wherein a subsequent operation is not commenced until the prior operation has been fully completed. Commonly, the first operation comprises transferring the information from a testing location to a receiving location. Typically, the receiving location is a physically separate location from the testing location and where the primary physician is located. The transfer of information may be across a local area network (LAN), a wide area network (WAN), or a global computer network. The receiving location may have a server or other computer system that receives the transferred information and at least temporarily stores the information onto its internal memory. Upon receipt of all of the transferred information, the transferred information is recorded or “burned” onto the portable computer-readable medium. Finally, the portable computer-readable medium containing all of the transferred data is provided with a label containing pre-selected information. A published portable computer-readable medium may comprise a label that contains various types of information such as patient identifying information, relevant dates, primary physician information, etc. An example of a medical media publisher is found in U.S. Ser. No. 11/604,097, titled Apparatus and Method for Publishing Computer-Readable Media, filed on Nov. 24, 2006, which is herein incorporated by reference.

Due to the large size of the medical image files to be recorded onto the portable computer-readable medium, however, a publisher of such media can quickly become backed up with multiple publish requests. This results in an inconvenient delay in delivering the published portable computer-readable medium to the end user. Accordingly, there is a need in the art for a method and apparatus to rapidly retrieve medical image files and record same on a portable computer-readable medium.

### BRIEF SUMMARY

According to one aspect, the subject application involves a method of labeling a computer-readable medium for storing a medical output produced by a medical modality, said medical output being formatted in compliance with a medical output formatting standard. The method includes receiving a transmission comprising the medical output from a host computer over a communication network. A portion of the medical output comprises label information that is to appear in a label region on the portable computer-readable medium, and is received substantially at a beginning portion of the transmission. The method further includes storing the medical output as it is received, at least temporarily, in a buffer memory to be subsequently stored onto the portable computer-readable medium; preparing the label information to appear in the label region from the portion of the medical output comprising the label information; and applying the label information within the label region on the portable computer-readable medium responsive to preparing the label information, wherein applying the label information within the label region is initiated in parallel with receiving a remaining portion of the transmission comprising the medical output.

According to another aspect, the subject application involves a A method of storing a medical output produced by a medical modality on a portable computer-readable medium, said medical output being formatted in compliance with a medical output formatting standard. The method includes receiving a transmission from a host computer over a communication network, where the transmission includes the medical output that is formatted in the standard medical format. The medical output is stored as it is received, at least temporarily, in a buffer memory operatively connected to a computer-readable medium publisher to be subsequently stored onto the portable computer-readable medium. A delay is established between a time when a portion of the medical output is received and a time when the portion of the medical output is stored on the portable computer-readable medium. Subsequent to the delay, the portion of the medical output is stored on the portable computer-readable medium in parallel with receiving the transmission from the host computer over the communication network.

According to another aspect, the present application involves A method of storing a medical output produced by a medical modality on a portable computer-readable medium, said medical output being formatted in compliance with a medical output formatting standard. The method includes receiving over a communication network a transmission comprising information to be used to establish a communication session over the communication network with a host computer. Responsive to receiving the transmission, an instruction is transmitted to the host computer to compress the medical output into a compressed medical output before the medical output is transmitted over the communication network to be stored on the portable computer-readable medium. The compressed medical output is received over the communication network and stored, at least temporarily, in a buffer memory operatively connected to a computer-readable medium publisher to be subsequently stored onto the portable computer-readable medium. Subsequent to completion of compression, the compressed medical output is stored on the portable computer-readable medium.

According to another aspect, the present application involves a method of storing a medical output produced by a medical modality on a portable computer-readable medium, said medical output being formatted in compliance with a medical output formatting standard. The method includes receiving, over a communication network, a transmission comprising information to be used to establish a communication session over the communication network with a host computer. Responsive to receiving the transmission, the medical output is received in an uncompressed format over the communication network from the host computer, and then locally compressed into a compressed medical output. The medical output is stored, at least temporarily, in a buffer memory to be subsequently stored onto the portable computer-readable medium; and subsequent to completion of compression, the compressed medical output is stored on the portable computer-readable medium. Storing the compressed medical output on the portable computer-readable medium requires less time than storing the medical output uncompressed on the portable computer-readable medium, wherein a delay incurred by locally compressing the medical output is less than a difference between a time required to store the medical output uncompressed on the portable computer readable medium and a time required to store the compressed medical output on the portable computer-readable medium.

According to yet another aspect, the present application involves a method of storing a medical output produced by a medical modality on a portable computer-readable medium, said medical output being formatted in compliance with a medical output formatting standard. The method includes receiving, over a communication network, a transmission comprising information to be used to establish a communication session over the communication network with a host computer. It is predicted that compression of the medical output will shorten a total length of time required to store the medical output on the portable computer readable medium relative to a total length of time required to store the medical output uncompressed on the portable computer-readable medium. Responsive to the predicting that compression of the medical output will shorten the total length of time, it is then predicted whether locally compressing the medical output subsequent to receiving the medical output over the communication network or instructing the host computer to compress the medical output prior to transmission of the medical output over the communication network will be a preferred compression that requires less time to complete. The preferred compression is initiated, and the medical output is received over the communication network from the host computer. The medical output received over the communication network is stored, at least temporarily, in a local buffer memory location to be subsequently stored on the portable computer-readable medium. Subsequent to completion of the preferred compression, the medical output is stored in a compressed format as a compressed medical output on the portable computer-readable medium.

According to yet another aspect, the present application involves a method of storing a medical output produced by a medical modality on a portable computer-readable medium, said medical output being formatted in compliance with a medical output formatting standard. The method includes estimating a size of the medical output to be stored, at least temporarily, in a buffer memory and subsequently on the portable computer-readable medium. A contiguous block of memory locations of the buffer memory is to be allocated for storing the medical output at least temporarily, and the contiguous block of memory locations allocated is approximately equal in size to the size of the medical output that was estimated. The medical output is stored, at least temporarily, in the contiguous block of memory locations of the buffer memory allocated for storing the medical output before storing the medical output on the portable computer-readable medium. The medical output is retrieved from the contiguous block of memory locations of the buffer memory to be stored onto the portable computer-readable medium, and the medical output is stored on the portable computer-readable medium.

According to yet another aspect, the present application includes a computer-readable medium publisher for storing a medical output produced by a medical modality on a portable computer-readable medium. The medical output is formatted in compliance with a medical output formatting standard. The computer-readable medium publisher includes a recording bay for writing the medical output that is formatted in the standard medical output formatting standard onto the portable computer-readable medium, and the medical output comprises at least a first portion and a second portion. A first buffer memory is provided for storing, at least temporarily, the first portion of the medical output received from a host computer over a communication network to be subsequently stored on the portable computer-readable medium. Similarly, a second buffer memory is provided for storing, at least temporarily, the second portion of the medical output received from the host computer over the communication network to be subsequently stored on the portable computer-readable medium, wherein the second buffer memory is accessible independent of the first buffer memory. A controller operatively connected locally to the computer-readable medium publisher for controlling the storing of the first portion of the medical output in the first buffer memory and the second portion of the medical output in the second buffer memory. The controller is operable to control reading of the first and second portions of the medical output in parallel from the first and second buffer memories to be stored as the medical output on the portable computer-readable medium.

According to yet another aspect, the present application involves a method of storing a medical output produced by a medical modality on a portable computer-readable medium, said medical output being formatted in compliance with a medical output formatting standard. The method includes receiving identification information from a host computer over a communication network and entering into a communication session with the host computer, wherein the medical output is to be transmitted from the host computer over the communication network and the identification information is received during an early portion of the communication session. A transmission is received over the communication network, said transmission comprising the medical output that is formatted in the medical formatting standard. It is established that the medical output is to be automatically recorded onto the portable computer-readable medium without operator intervention once at least a portion of the medical output has been received. An appropriate type of the portable computer-readable medium is selected to be used to store the medical output, wherein selecting the appropriate type of the portable computer-readable medium occurs before receiving the transmission comprising the medical output is complete. Responsive to selecting the appropriate type of the portable computer-readable medium, the appropriate type of portable computer-readable medium is transported to a destination as part of a publication process for storing the medical output onto the portable computer-readable medium, wherein transporting the appropriate type of portable computer-readable medium is accomplished automatically, without operator intervention. The medical output is locally stored, at least temporarily, in a buffer memory to be subsequently stored on the appropriate type of portable computer-readable medium, and storing the medical output from the buffer memory onto the appropriate type of portable computer-readable medium.

According to yet another aspect, the present application includes a method of performing a job that includes storing a medical output produced by a medical modality on a portable computer-readable medium, said medical output being formatted in compliance with a medical output formatting standard. The method includes receiving a transmission according to a transmission protocol employed in a medical network, said transmission comprising the medical output that is compliant with the medical output formatting standard. The medical output is at least temporarily stored as it is received in a buffer memory to be subsequently stored on a portable computer-readable medium, wherein the portable computer-readable medium is one of a plurality of different portable computer-readable media available to a computer-readable media publisher utilized for storing the medical output on the portable computer-readable medium. A first portable computer-readable medium is selected as an appropriate portable computer-readable medium to be used to store the first medical output. Responsive to selecting the first portable computer-readable medium as the appropriate portable computer-readable medium, an availability of the first portable computer-readable medium from among a plurality of portable computer-readable media available to the computer-readable media publisher for storing medical output is determined, It is sensed that the first portable computer-readable medium is unavailable, and responsive to said sensing, the job comprising storing the medical output on the first portable computer-readable medium is queued until the first portable computer-readable medium becomes available to the computer-readable media publisher. Another job that includes storing another medical output on a second portable computer-readable medium that is available to the computer-readable media publisher is initiated while the job is queued.

According to yet another aspect, the present application involves a computer readable medium publisher for receiving a medical output produced by a medical modality over a communication network and storing said medical output onto a portable computer readable medium, said medical output being formatted in compliance with a medical output formatting standard. The computer readable medium publisher includes a network interface for communicating with and receiving the medical output from a host computer storing the medical output over the communication network, and a first recording bay for storing the medical output received over the communication network onto the portable computer readable medium. Also provided is at least one of: an automated feeder for transporting the portable computer readable medium to the first recording bay, and a printer for applying label information to a label region. A control unit is provided for controlling transmission of the medical output to the first recording bay to be stored on the portable computer readable medium and operation of the at least one of the automated feeder and the printer. A first connector is provided for extending and establishing communication between the control unit and the first recording bay, wherein the medical output is to be transmitted to the first recording bay by the first connector to be stored on the portable computer readable medium. A second connector that is electrically independent of the first connector is also provided, said second connector extending and establishing communication between the control unit and the at least one of the automated feeder and the printer for transmitting control signals to the at least one of the automated feeder and the printer.

According to yet another aspect, the present application includes a method of storing a medical output produced by a medical modality on a portable computer-readable medium, the medical output being formatted in compliance with a medical output formatting standard. The method includes communicating with a host computer storing the medical output over a communication network to establish a communication session with the host computer; and receiving a transmission over the communication network, wherein the transmission comprises the medical output formatted in the standard medical output formatting standard. The medical output is stored, at least temporarily, in a buffer memory to be subsequently read from the buffer memory and stored on the portable computer-readable medium. A referential link is established between the medical output in the buffer memory and a desired arrangement of the medical output on the portable computer readable medium on which the medical output is to be stored. The referential link is referred to in order to read the medical output from the buffer memory to be stored on the portable computer-readable medium, The medical output read from the buffer memory is transmitted to a recording bay, and the medical output is stored on the portable computer readable medium according to the referential link.

According to yet another aspect, the present application involves a method of publishing a portable computer-readable medium for storing a medical output produced by a medical modality, said medical output being formatted in compliance with a medical output formatting standard. The method includes receiving an identifying attribute from a host computer over a communication network and entering into a communication session with the host computer; and associating a parameter set with the identifying attribute, wherein the parameter set comprises a parameter that defines an operational function of a portable computer-readable medium publisher for storing the medical output onto the portable computer-readable medium to minimize a length of time required to complete publication of the portable computer-readable medium. A transmission is received over the communication network, said transmission comprising the medical output to be stored on the portable computer-readable medium. The medical output is locally stored, at least temporarily, in a buffer memory to be subsequently stored on the portable computer-readable medium; and stored from the buffer memory on to the portable computer-readable medium.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows a perspective view of a computer-readable medium publisher according to one embodiment;

FIG. 2 shows a cutaway view of a portion of a computer-readable medium publisher with a protective cover removed according to one embodiment;

FIG. 3 shows an exploded view of a portion of a computer-readable medium publisher according to one embodiment;

FIG. 4 shows an assembly view of a portion of a computer-readable medium publisher according to one embodiment;

FIG. 5 shows a perspective view of a portion of a computer-readable medium publisher with a published media receiver removed to expose a memory module operatively coupled to a memory-module interface according to one embodiment;

FIG. 6 shows a block diagram illustrating an arrangement of an embodiment of a control unit operable to control operation of the computer-readable medium publisher according to one embodiment;

FIG. 7 shows an example of a medical image file that is DICOM standard compliant and includes a DICOM header and DICOM image data;

FIG. 8 shows an example of a PACS network comprising a computer readable media publisher;

FIG. 9A shows an illustrative embodiment of a timing diagram for performing at least two operations included in storing a medical image onto a portable computer-readable medium in parallel;

FIG. 9B shows an illustrative embodiment of a timing diagram for applying label information to a portable computer-readable medium in parallel with receiving a medical image file over a communication network to be stored on the portable computer-readable medium;

FIG. 10 shows an illustrative embodiment of a portable computer-readable medium with the label information applied;

FIG. 11 shows an illustrative embodiment of a timing diagram for storing a medical image file onto a portable computer-readable medium in parallel with receiving the medical image file over a communication network;

FIG. 12A shows an illustrative arrangement of medical output on a portable computer-readable medium in compliance with a DICOM standard;

FIG. 12B shows an illustrative embodiment of referentially linking medical outputs received and stored in a buffer memory to an arrangement on a portable computer readable medium;

FIG. 13 is an illustrative embodiment of referential links established between medical outputs stored in folders within a buffer memory and an arrangement on a portable computer-readable medium;

FIG. 14 is an illustration of a buffer memory portion of a computer-usable memory divided into an array of memory locations including clusters and fragments;

FIG. 15 is an illustration of a RAID controller for storing, in parallel, a medical output in two buffer memories and subsequently reading the medical output in parallel from the two buffer memories;

FIG. 16 is an example of a display device indicating that publication of a medical image file onto a CD has been queued because the CD is unavailable and that publication of another medical image file onto a DVD has continued uninterrupted by the queuing of the publication of the medical image file onto the CD; and

FIG. 17 is a flow diagram illustrating an embodiment of an adaptive compression routine for compressing a medical output to be stored on a portable computer-readable medium.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

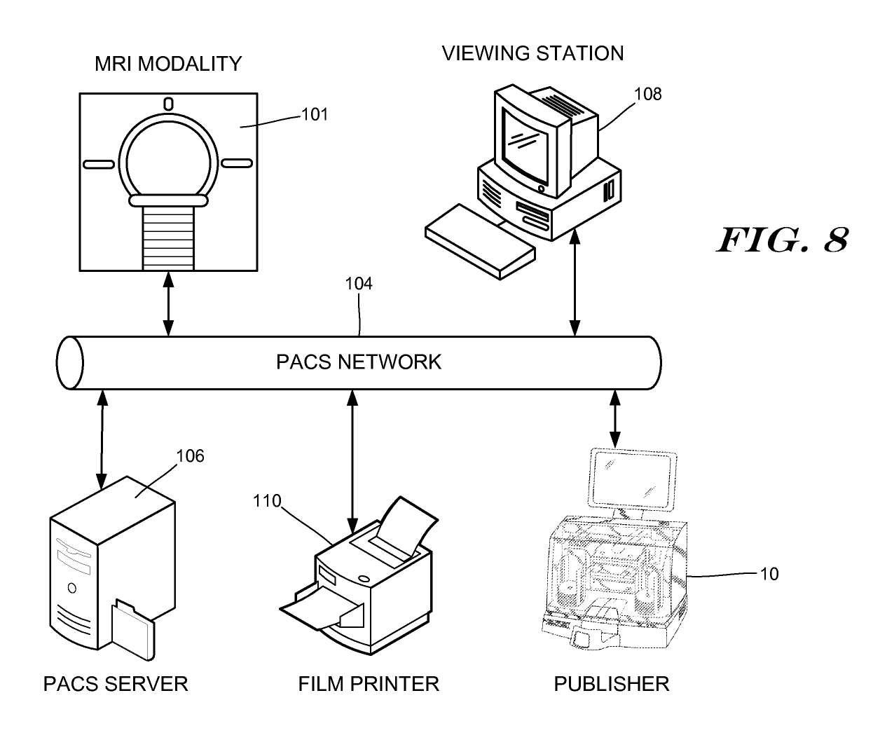

The subject application relates to a method and apparatus for storing a medical modality output (referred to herein as a “medical output”) that is formatted in a standard medical output format onto a portable computer-readable medium. The standard medical format can be any format in which the medical output (e.g., x-ray, MRI scan, electrocardiogram, etc. . . . ) produced by a medical modality is commonly formatted, and that can be presented to a user via a computer terminal provided with a compatible viewer or other media presentation software that is executable by a computer to reproduce or otherwise present the medical output to the user. Such media presentation software can optionally be stored on the portable computer-readable medium 12 with the medical output, and can be executed from the portable computer-readable medium 12. The medical output from any medical modality can be stored on a portable computer-readable medium 12 as described herein, however, for the sake of clearly and to particularly describe the present technology, an example of a medical output in the form of a medical image 94 (FIG. 7) will be used herein. But it is to be understood that the output of a medical modality can include any image, audio track, data plot, graphical representation, motion picture, text report, any other type of media file output by a medical modality, or any combination thereof, is included within the scope of the technology described herein. Thus, references to a medical image 94 herein are equally applicable to the other medical modality outputs.

Examples of the medical output formatting standard include, but are not limited to, a format that is compliant with Part 10 (PS 3.10-2008) or any other part of the Digital Imaging and Communications in Medicine (“DICOM”) file format established by the National Electrical Manufacturers Association (“NEMA”), compliant with the Portable Data for Imaging (“PDI”) standards maintained by IHE International, or both for example. The method and apparatus herein maximize throughput, and minimize the time to first disc, which is the time required to complete publication of a portable computer-readable medium 12 to be distributed to a recipient from a time when publication of the portable computer-readable medium 12 is initiated. Preparation includes at least one of storing the medical output produced by a medical modality onto the portable computer-readable medium 12 and applying human-readable (i.e., visually readable without first requiring conversion by a computer or other reader) label information within a label region on the portable computer-readable medium 12.

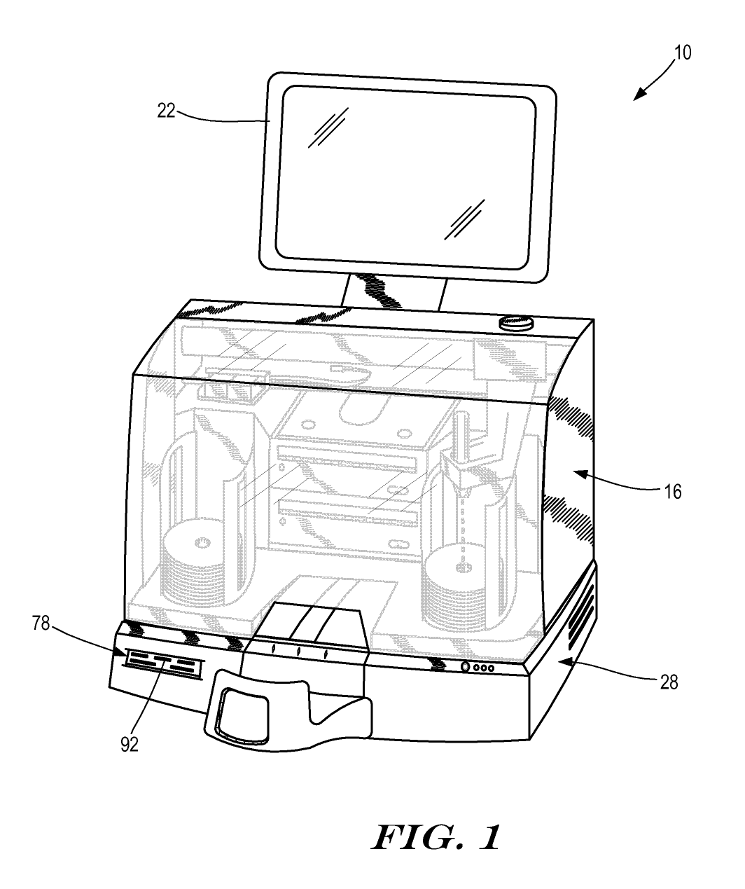

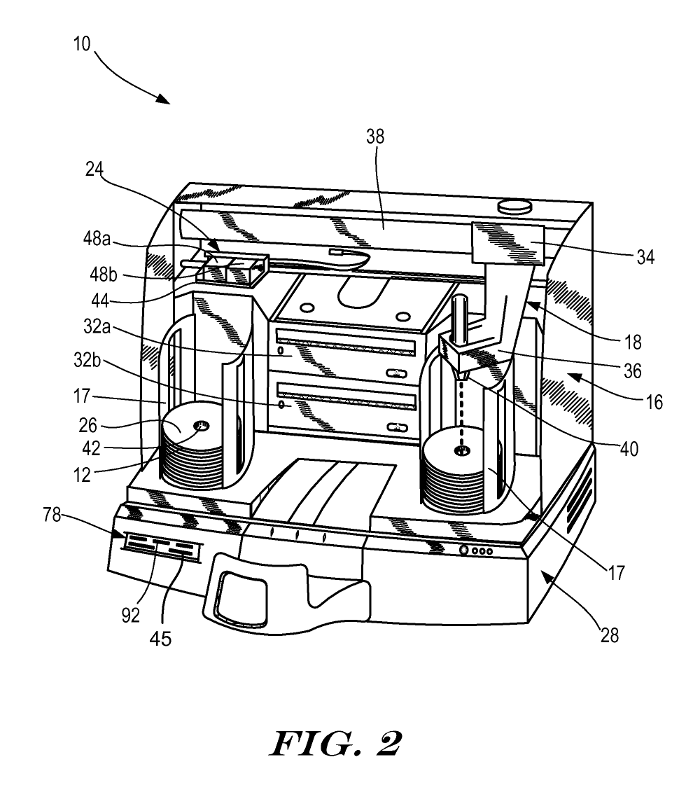

FIG. 1 shows an illustrative embodiment of a computer-readable-media publisher 10 in accordance with an embodiment of the present invention, an example of which is described in U.S. Patent Application Publication No. 2008/0122878 to Keefe et al., the entirety of which is incorporated herein by reference. Although such a publisher 10 can be utilized in any field in which it is desirable to record electronic data onto one or more portable computer readable media, the embodiments of the present invention are described below as being used in the medical field for the sake of clarity. Such embodiments are described herein as storing the medical image 94 or other medical output onto the portable computer-readable medium 12 (FIG. 2), applying label information onto the portable computer-readable medium, or a combination thereof, resulting in publication of the portable computer-readable medium. The process of publishing the portable computer-readable medium 12, which includes at least one of storing the medical output onto the portable computer-readable medium and applying the label information, can be arranged into “jobs”. Each job results in the publication of one or a plurality of portable computer-readable media 12 storing medical output that can optionally comprise one or more medical images or other forms of output produced by a medical modality. All medical output included in the job is stored on the portable computer-readable medium 12 according to one or more parameters in a parameter set, which is also referred to herein as a “job profile” as described in detail below. For the illustrative embodiments, the medical image 94 representing the medical output is not limited to electronic data representing only medical images, but also includes all associated charts, files, and the like. And as mentioned above, the medical output can optionally be formatted in compliance with Part 10 (PS 3.10-2008) or any other part of the DICOM standard established by the National Electrical Manufacturers Association (“NEMA”), in compliance with the PDI standards maintained by IHE International, or both, to be stored on the portable computer-readable medium 12. The medical images referred to herein are in electronic form, and can optionally be broken into electronic files to be recorded onto the portable computer-readable medium 12, and can be a document, image, audio file, video file, or any combination thereof, and other such files related to the medical image captured by a medical modality.

With continued reference to FIG. 1 and now to FIG. 2 as well, the publisher 10 records the electronic data onto the portable computer-readable medium 12 to be given to the end user. The end user can subsequently retrieve and review the electronic data from the computer-readable medium 12 in a private setting such as the patient's home, or the radiologist's office, with a personal computer executing the media presentation software. Alternately, the end user can be a medical facility different from the facility that captured or otherwise created the medical image 94. This different facility can import data from the medical image 94, including the medical images and patient information, to be entered into a network maintained by the different facility.

As shown in FIGS. 1 and 2, the publisher 10 comprises a recorder 16 including one or more recording bays 32a, 32b for recording the electronic data onto the portable computer-readable medium 12, and an automated feeder 18 that can be provided to the recorder 16 for transporting the portable computer-readable medium 12 from a storage bin 17 to the recording bays 32a, 32b without intervention by an operator once publication of the portable-computer readable medium 12 has been initiated. That is, once an instruction to publish a portable computer-readable medium 12 has been entered by an operator of the publisher 10 or another computer terminal operatively connected to communicate with a host computer as described in detail below, the automated feeder 18 can supply the computer-readable medium 12 retrieved from the storage bin 17 to the recorder 16 without further intervention by the operator. The application of label information and/or storing of the medical output onto the portable computer-readable medium 12 can also optionally be automated and performed without operator intervention.

In addition to the recorder 16 and automated feeder 18, the publisher 10 further comprises a user interface 22 which, for some embodiments herein can be a touch-screen display panel, for example, presenting the operator with one or more options that the operator can select to enter a command for controlling operation of the publisher 10 as described in detail below. A printer 24 is provided for printing onto a surface of a label 26 at least variable label content that is related to the electronic data that can be retrieved from the portable computer-readable medium 12 and reviewed by the end user. A microprocessor such as a multiple-core processor, for example, or other suitable central processing unit 80 provided to a control unit 28 executes computer-executable logic to carry out operations that control at least one of: the delivery of the medical image 94 to the one of the recording bays 32a, 32b to be stored onto the portable computer-readable medium 12; operation of the printer 24 for printing the label content onto the surface of the label 26; operation of the automated feeder 18; and coordination of these functions.

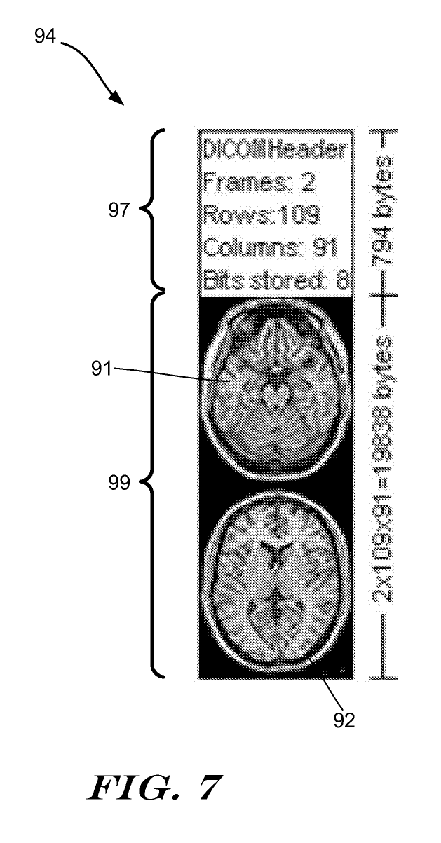

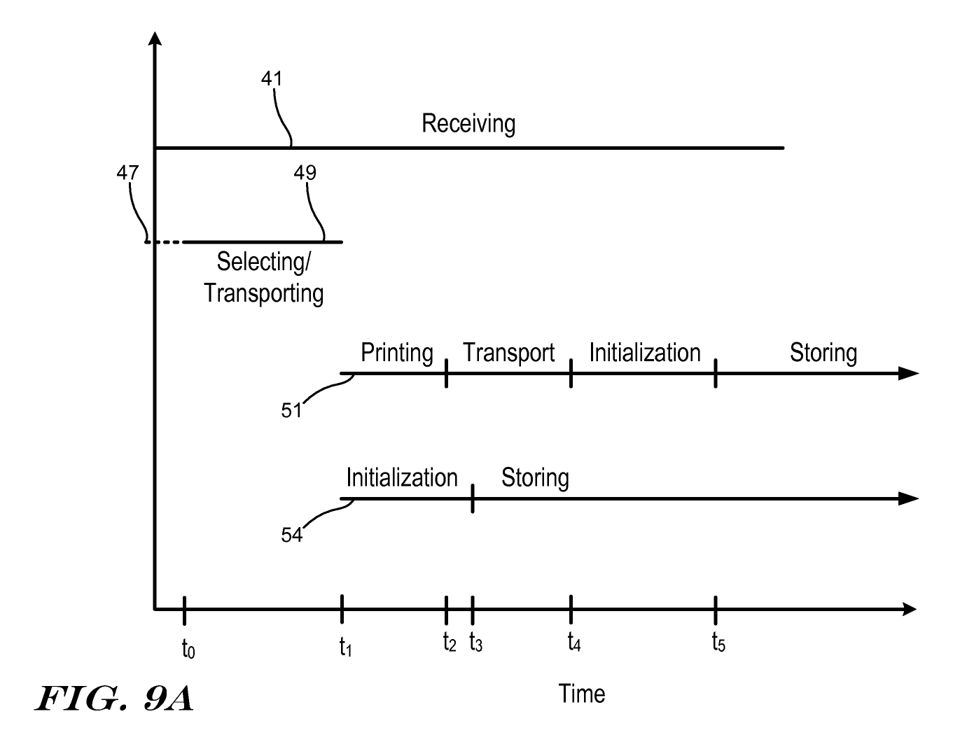

The control unit 28 also includes other conventional computer components such as a volatile operational memory such as random access memory (“RAM”) 79 (FIG. 6) for temporarily storing information during operation of the publisher 10. Further, a network interface 81, which can be a wireless network adaptor compliant with the IEEE 802.1x standards, for example, or any high-speed LAN connection such as a 10/100 Ethernet adaptor, for example, enables the publisher 10 to receive the medical image and other medical outputs over the communication network 104 (FIG. 8) from a host computer and/or a medical modality 101 (shown as an MRI scanner in FIG. 8) as discussed below. The host computer can be a medical output storage device such as a PACS server 106, a computer workstation 108 connected to the network 104, or any other computer storage device in communication with the network 104. The host computer can communicate via any conventional network communication protocol such as TCP/IP, for example, and can optionally be hardwired directly to the publisher 10 via a USB, Ethernet, Firewire, or any other suitable connector, or remotely located to communicate with the publisher 10 over the communication network 104. The communication network 104 (FIG. 8) can include the publisher 10 and, operatively connected to communicate with the publisher 10, at least one of a: computer database storing the medical output in compliance with the medical output formatting standard, a medical modality, and a medical workstation associated with a medical care provider. Bus systems 85a, 85b (FIG. 6) can be provided to the control unit 28 and the recorder 16 for transmitting signals between the various components of the control unit 28 and recorder 16.

The computer-readable medium 12 is said to be portable in that it is a mass storage medium that can be used to store information according to a standard that enables the end user to retrieve and review the electronic data with computers other than the publisher 10 itself. In other words, the portable computer-readable medium 12 can be a passive medium to be temporarily inserted into a compatible drive unit of a personal computer or other computer terminal for retrieving and reviewing the electronic data there from. Examples of suitable portable computer-readable media 12 include, but are not limited to, optical media such as a compact disc (also commonly referred to as a “CD”, “CD-ROM”, “CD+R”, “CD-R”, “CD-RW”—collectively referred to herein as “CD”); digital video disc (also commonly referred to as a “digital versatile disc,” and including “DVD”, “DVD-ROM”, “DVD-R”, “DVD-RW”, “DVD+R”, “DVD+RW”, “DVD-RAM”, and the like—collectively referred to herein as “DVD”); Blu-ray Discs such as BD-R, BD-RE, and the like—collectively referred to herein as “Blu-ray Disc”); HD-DVD; and the like. Another suitable portable computer-readable medium 12 includes a USB flash drive commonly referred to as a jump drive or memory key that includes a EEPROM based memory integrated with a USB interface.

According to the embodiment shown in FIGS. 2 and 6, the recorder 16 includes at least a first optical recording bay 32a, and optionally a second optical recording bay 32b (the one or more optical recording bays 32a, 32b collectively referred to herein as recording bays 32), adapted to record electronic data onto optical portable computer-readable media 12 to be given to the end user. The two optical recording bays 32a, 32b can both be CD writer drives, they can both be DVD writer drives, they can both be Blu-ray Disc writers, or any combination thereof. Further embodiments include either or both of the optical recording bays 32a, 32b in the form of a combined CD/DVD/Blu-ray writer drive capable of selectively storing the medical image 94 (FIG. 7) onto any of the respective optical formats. The CD, DVD and Blu-ray Disc writers record data onto a data storage side of a CD, DVD and Blu-ray disc, respectively, by impinging laser light from a laser source onto said data side. The laser light forms a pattern on the data storage side of the CD, DVD and/or Blu-ray Disc, optionally on a plurality of different layers of that medium, to thereby record the medical image 94 onto the CD, DVD and/or Blu-ray Disc.

In addition to, or instead of one or both of the two optical recording bays 32a, 32b in FIG. 2, the recorder 16 can suitably be provided with any number of recording bays 32a, 32b, and optionally a recording bay 78 for recording the medical image 94 onto a portable computer-readable medium other than a CD and DVD. For example, a USB port 92 of the recording bay 78 allows a USB flash drive, external USB hard drive, and the like to be operatively connected to the publisher 10 for storing the medical image 94 thereon. The recording bay 78 can also optionally include additional format ports such as a SD card port 45 and the like, offering yet other alternatives to the optical format portable computer-readable medium 12. For the sake of brevity, however, the method and apparatus are described below as storing a medical image 94 onto an optical portable computer-readable medium 12.

For the embodiments that store medical images 94 onto optical computer-readable media 12, the automated feeder 18 of the publisher 10 retrieves a proper computer-readable medium 12 for storing a particular medical image 94 from a supply bin 17 as described in detail below. The portable computer-readable medium 12 retrieved is inserted into one of the recording bays 32a, 32b from where the electronic data can be recorded. Each supply bin 17 can be an open column approximating the diameter of an optical computer-readable medium 12 that is defined by one or more plastic partitions. The automated feeder 18 can include any device that can be computer controlled, and autonomously-driven according to the execution of computer-executable logic. For example, a suitable automated feeder 18 can include a robotic arm 36 that can be positioned at a plurality of locations along a track 38. According to such embodiments, a drive motor 34 is activated according to the instructions from the computer-executable logic executed by the control unit 28 to adjust the position of an outwardly extending arm 36 along a transverse track 38. The automated feeder 18 can be operatively connected to communicate with the central processing unit 80 (FIG. 6) to receive control commands from the control unit 28 over the dedicated control signal path 77c. The arm 36 can be positioned to travel over the two supply bins 17 storing the optical portable computer-readable media 12 such that a medium grasping tool 40 is generally aligned with a central axis 41 of an aperture 42 formed in each portable computer-readable medium 12. Once properly aligned, the grasping tool 40 can be lowered into the bin 17 and into the aperture 42 of the portable computer-readable medium 12 to be inserted into one of the recording bays 32a, 32b. A diameter of the grasping tool 40 can be enlarged once inside the aperture 42 to secure the portable computer-readable medium 12 to the feeder 18.

With the portable computer-readable medium 12 secured to the feeder 18, the grasping tool 40 along with the portable computer-readable medium 12 is elevated out of the storage bin 17. The position of the arm 36 is then adjusted along the transverse track 38 toward the first or second recording bay 32a, 32b into which the portable computer-readable medium 12 is to be inserted. A door of the recording bays 32a, 32b can be opened to allow a supporting tray, such as the tray that can be extended out of a conventional CD/DVD/Blu-ray Disc writer for example, to be extended out of the recording bays 32a, 32b for receiving the portable computer-readable medium 12 in a manner known in the art. Once the portable computer-readable medium 12 is supported above the extended supporting tray, the diameter of the grasping tool 40 can be reduced to allow the aperture 42 of the portable computer-readable medium 12 to pass over the grasping tool 40. This results in the portable computer-readable medium 12 falling onto the supporting tray, which is then retracted back into the recording bays 32a, 32b. Once the optical computer-readable medium 12 is disposed within one of the recording bays 32a, 32b, it is to be spun from its initial stationary state to a suitable angular velocity to achieve a desired write speed as part of a “spin-up” phase. Upon reaching the suitable angular velocity, the portion located a given radial distance from the center of the CD/DVD/Blu-ray Disc/HD-DVD, etc. . . . at which the medical output is to be written rotates at a known velocity relative to a laser that is used to write the medical output onto the optical computer-readable medium 12, and thus, writing of the medical output at a desired speed can be controlled. During the initial stages of the spin-up phase, the control unit 28 also initiates interrogation of the computer-readable medium 12 in one of the recording bays 32a, 32b with the laser to determine the type (e.g., CD, DVD or Blu-ray Disc) that is present. Based on this interrogation the control unit 28 can execute the proper computer-executable logic for controlling the storage of the medical image 94 onto the type of the optical computer-readable medium 12 that is detected.

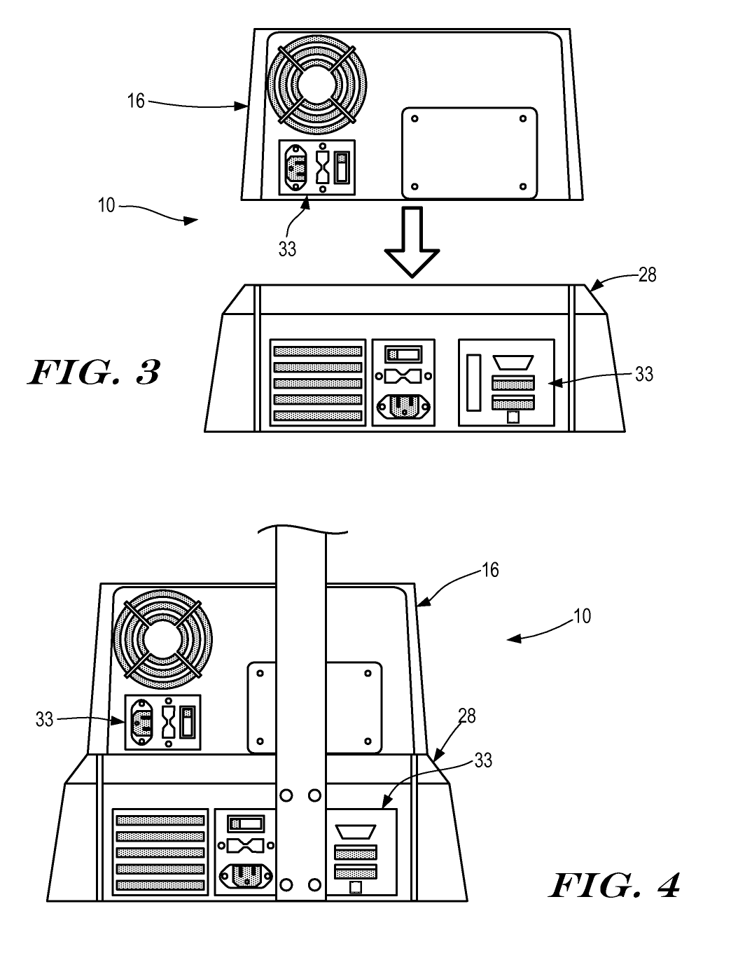

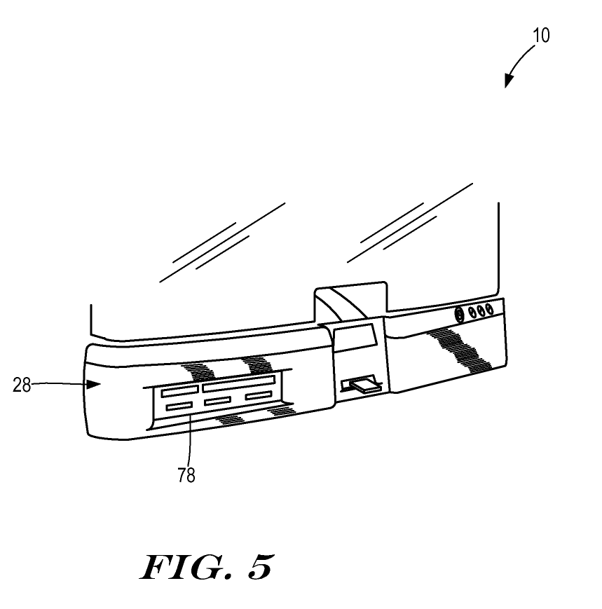

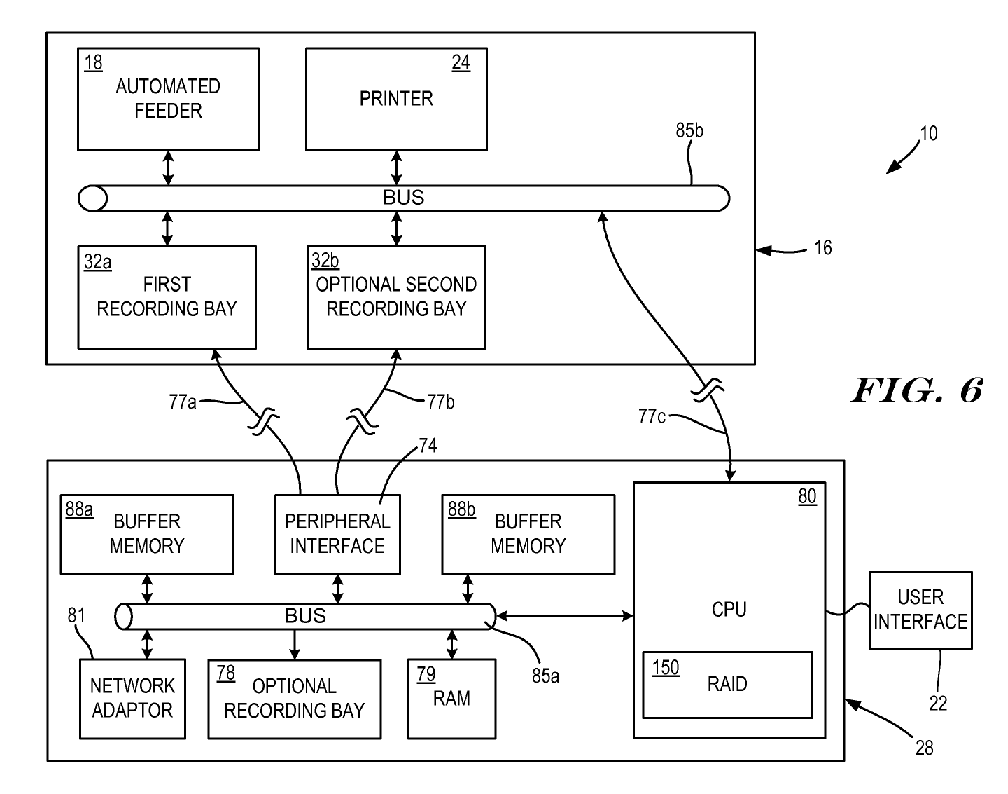

As shown in FIGS. 3 and 4, the recorder 16 and the control unit 28 are modular units, and the control unit 28 acts as a base on which the recorder 16 rests when the publisher 10 is assembled. The control unit 28 controls the receiving and processing of medical images 94 over a communication network and subsequent delivery of the received medical images 94 to the optical recording bay(s) 32a, 32b, other recording bay 78, or a combination thereof. However, the recorder 16 can also include the automated feeder 18 and the printer 24 for applying label content onto a label for the computer-readable medium 12, each of which can also be controlled by the control unit 28. To maximize the independent, and optionally parallel transmission of the medical output to the optical recording bay(s) 32a, 32b while controlling operation of the automated feeder 18 and/or printer 24, and receiving the medical image 94 and other medical outputs through the network adaptor 81 (FIG. 6) over the communication network 104 (FIG. 8) from a host computer and/or a medical modality 101 (shown as an MRI scanner in FIG. 8) a dedicated data transmission path can be established between the control unit 28 and each of the recording bay(s) 32a, 32b, automated feeder 18 and printer 24 as illustrated schematically in FIG. 6 to maximize the available bandwidth for transmitting signals therebetween. Thus, a first dedicated data transmission path 77a can extend between a high-speed peripheral interface 74 in communication with first and second buffer memories 88a, 88b of the publisher 10 via bus system 85a. Likewise a second dedicated data transmission path 77b can extend between a high-speed peripheral interface 74 in communication with first and second buffer memories 88a, 88b of the publisher 10 via bus system 85a. The first and second data transmission paths 77a, 77b can be electrically isolated from each other to primarily transmit, or only transmit the medical images 94 between the first and second buffer memories 88a, 88b and the recording bays 32a, 32b. Similarly, a dedicated control signal path 77c can be established between the central processing unit 80 of the control unit 28 and the automated feeder 18 and/or printer 24 to control operation of one or both of those features.

For example, to simplify assembly of the recorder 16 and the control unit 28, externally-exposed communication ports 33 (FIGS. 3 and 4) can be exposed at a rear surface of both the recorder 16 and control unit 28. A suitable cable such as an IEEE 1394 cable (commonly referred to as a “Firewire” cable), a USB 2.0 cable, any serial advanced technology attachment (commonly abbreviated as “SATA”) such as external SATA (commonly abbreviated “eSATA”), Fibre Channel, small computer system interface (“SCSI”), HDMI, any other suitable cable, or any combination thereof, can be operatively connected to establish one or more of the first and second data transmission paths 77a, 77b and the control signal path 77c between corresponding communication ports 33 as shown schematically in FIG. 6. Thus, a USB 2.0 cable can be connected between the pair of USB 2.0 compliant communication ports (one operatively connected to, and in communication with each of the printer and/or automated feeder 18 and the central processing unit 80) to establish the dedicated control signal path 77c for transmitting control signals from the control unit 28 to the automated feeder 18 and/or printer 24. Likewise, a dedicated eSATA cable can be connected between eSATA compatible communication ports provided to each of the control unit 28 and the optical recording bays 32a, 32b. In other words, a first eSATA cable can be installed between an eSATA compatible communication port provided to each of the control unit 28 and the recorder 16 to establish the first data transmission path 77a for transmitting the medical image 94 between the first and second buffer memories 88a, 88b to a first optical recording bay 32a. Similarly, a second eSATA cable can be installed between another eSATA compatible communication port provided to each of the control unit 28 and the recorder 16 to establish the second data transmission path 77b for transmitting another medical image 94 between first and second buffer memories 88a, 88b to a second optical recording bay 32b provided to the recorder 16. According to such embodiments, operation of the automated feeder 18 and/or the printer 24 can be controlled without disrupting, interfering with, or delaying the transmission of a medical image 94 from the control unit 28 to one of the optical recording bays 32a, 32b or another recording bay 78. Also, according to such embodiments, transmission of a medical image 94 from the control unit 28 to one or more of the optical recording bays 32a, 32b, or 78 can be completed without disrupting, interfering with, or delaying the transmission of a medical image 94 from the control unit 28 to another one or more of the optical recording bays 32a, 32b, or 78.

For embodiments where the electronic data are to be recorded onto a plurality of different types (e.g., CDs and DVDs) portable computer-readable media 12, each different media 12 can be stored in a separate storage bin 17. Thus, there can optionally be as many storage bins 17 as there are different types of portable computer-readable media 12. Further, the storage bin 17 in which each known type of portable computer-readable media 12 is stored can be programmed into a computer-accessible memory, such as a hard disk drive for example, provided to the publisher 10 for automated retrieval of the proper optical portable computer-readable medium for a particular storage application.

In addition to publishing a plurality of different types of media (e.g., CDs, and DVDs) available to the publisher 10, other factors can make the portable computer-readable medium 12 in one storage bin 17 different from a portable computer-readable medium stored in another storage bin 17, even if both are the same type of medium. For example, the price of portable computer-readable media 12 can vary based on the finish of a surface of a label 26 provided to the portable computer-readable media 12. Flat label finishes that are substantially non-reflective are relatively inexpensive relative to glossy finishes, which have a shine that makes them appear to be at least partially reflective. Glossy finishes offer a viewer a professional finish that is very appealing for marketing purposes. The glossy finishes are typically to be reserved for end users not affiliated with the medical facility responsible for recording the electronic data, and marketing material may be printed on such a label 26 to be disseminated outside of the medical facility in addition to material identifying the end user or the electronic data recorded on the respective portable computer-readable medium 12.

In contrast, it is not necessary to include marketing material on a copy of the portable computer-readable medium 12 to be given to a physician who is going to simply review the electronic data regarding a patient since the physician is affiliated with the medical facility. Thus, publishing costs can be minimized by recording the electronic data onto the portable computer-readable medium 12 for the physician that is provided with a flat-finish label 26. The label information can optionally comprise at least information to enable a determination of a number of computer-readable media 12 required to store all of the medical outputs to be stored for a given job, and the plurality of computer-readable media 12 can be labeled to identify an order of one or more (e.g., the second and subsequent computer-readable media 12) of the computer-readable media 12 in the overall sequence for that job Alternately, the label information can be independent of a substance of the medical output to be stored on the computer-readable medium 12.

Further, to maximize the speed at which the label information is applied (and thereby minimize the time required to publish a portable computer-readable medium 12), the label information can include minimal graphical content, and optionally also minimal text content to keep the label information to a minimum. Other label formatting parameters consistent a job profile optimized for speed of publication can include, but are not limited to: a low print quality in exchange for rapid printing speed; a limit (or exclusion) of graphical label information in the label information to be applied to the label region; a maximum number of colors in which the label information is to be printed (e.g., one color such as black, two colors, or other small numbers of colors); or any combination thereof.

Other parameters in the parameter set can used in addition to or instead of the parameters relating to application of label information to establish operational functions such as applying label information, storing the medical output onto the portable computer-readable medium 12, and other operational functions performed during publication of the portable computer-readable medium 12. For example, a parameter in the parameter set can optionally define a type of portable computer-readable medium 12 (e.g., CD, DVD, Blu-ray, HD-DVD, USB flash drive, etc. . . . ) for storing the medical output. Again to minimize the time required to publish a portable computer-readable medium 12, the type of portable computer-readable medium 12 defined by the parameter can include a maximum allowable storing or writing speed to enable the recording bay 32a, 32b or 78 to store the medical image 94 the quicker than on any other type of portable computer-readable medium 12 available to the portable computer-readable medium publisher 10.

According to another example, the parameter set can optionally include a parameter that defines a maximum amount of medical output to be stored on the portable computer-readable medium 12 for a job that, when the amount is stored on the portable computer-readable medium 12, publication can be considered to be complete. According to an embodiment, the parameter can establish limit the maximum amount of medical output to a single collection of related medical images that collectively form a single study performed on a patient, for example. To illustrate the study, if a patient has an x-ray examination to diagnose a broken bone, then the study can optionally include a plurality of x-ray images from different angles. When this one study is recorded onto the portable computer-readable medium 12 according to this parameter, the publisher 10 will immediately complete the publication process.

Similarly, a parameter can be provided to dictate that storing the medical output from at least one buffer memory 88a, 88b on the portable computer-readable medium 12 is to be initiated in response to a termination of the communication session between the publisher 10 and the host computer. When the communication session is terminated the publisher 10, operating according to the parameter can conclude that all of the medical output has been received and is ready to be stored on the portable computer-readable medium 12 since without the communication session no additional medical output can be received from the host. Thus, the closing of the communication session signals the end of the receiving step without requiring the publisher 10 to wait for a lengthy timeout to occur.

Any or all of these parameters can optionally be stored locally by a computer-readable memory provided to the publisher 10, such as one or both of the buffer memories 88a, 88b, and not shared with other networked resources. The publisher can be instructed which parameters to use in controlling a functional operation of the publication process by associating an identifying attribute received over the communication network from a host computer storing the medical output to be stored on the portable computer-readable medium 12. For instance, upon initiating a communication session, a PACS server will transmit an Application Entity Title (“AE Title”) as the identifying attribute according to the DICOM standard. The publisher 10, upon receiving this AE Title, can compare the AE Title to a lookup table or other reference to determine which parameters to use to publish a portable computer-readable medium 12 with the medical output that will follow from the PACS server. Other examples of a suitable identifying attribute to correlate to the one or more parameters in a parameter set include, but are not limited to: a custom DICOM tag established in the DICOM header portion 97 (FIG. 7), a signal from a medical modality 101; network information such as the IP address of the publisher 10 or host computer, or a communication port over which the communication session is established; and the like.

The label information can include variable label content that is human readable without computer assistance to be printed onto the label 26 provided to the portable computer-readable medium 12 by the publisher 10 during the publication process described below. The variable label content can be specific to the end user, the electronic data recorded onto the portable computer-readable medium 12, or a combination thereof, and as the name suggests, can vary for each job. Other label information may include content that is fixed, and optionally the same for a plurality of portable computer-readable media 12 published with the publisher 10 that are each to be distributed to different end users. An example of this other label information is the name of the medical care provider that captured the medical output. For example, the variable label content can serve to differentiate each portable computer-readable medium 12 storing different electronic data. Examples of such variable label content include, but are not limited to, a patient's name, address, patient identification number, subject of the electronic data, the number of each portable computer-readable medium 12 in a series, patient visit date, patient discharge date, the date on which the medical image was captured, the name of the patient's primary physician, the physician conducting the examination during which the medical image was captured, any other patient or electronic-data specific information, any label information independent of the substance of the medical image and optionally unrelated to the medical image, and any combination thereof.

The printer 24 prints onto a surface of the label 26 at least the variable label content. As mentioned above, the variable label content is related to the electronic data that can eventually be retrieved from the computer-readable medium and reviewed by the end user after the portable computer-readable medium 12 is ejected from the publisher 10. The printer can optionally print only the variable label content onto a glossy finish label 26, only the variable label content onto a flat finish label 26, both the variable label content and the fixed label content onto a flat finish label 26, or both the variable label content and the fixed label content onto a glossy finish label 26. Further, other embodiments can print any such combination including at least the variable label content onto a label 26 having a finish other than glossy or flat. If only the variable label content is to be printed by the printer 24, the label 26 can optionally include pre-printed fixed label content thereon and the variable label content is printed in designated regions of the label 26 as described in detail below.

The printer 24 can utilize any suitable printing technology and printing medium to print label content onto a label region of the computer-readable medium 12. For example, the printer 24 can be an inkjet type printer that sprays a printing medium in the form of small ionized drops of a liquid ink onto the computer readable medium 12 (or a label substrate to be applied to the computer-readable medium 12) to print the label content. However, the printer 24 is not so limited. Alternate embodiments of the printer 24 utilize a toner according to a laser printing technology to print the label content. Yet alternate embodiments of the printer utilize a solid printing medium that undergoes a phase change from a solid to a liquid before being applied within the label region to print the label content. Yet other embodiments of the printer 24 can apply a dye printing medium to print the label content in a dye sublimation printing process. The discussion below concerning the application of the ink to the label region of the computer-readable medium 12 to print the label content is illustrative, and is equally applicable to the various other printing media to be applied within the label region on the computer-readable medium 12 to print the label content.

The illustrative embodiment of the printer 24 in FIG. 2 includes an ink-cartridge carriage 44 that can also travel along a second transverse axis 46 in a manner analogous to the feeder 18. The carriage 44 supports one or more ink cartridges 48a, 48b that dispense fine drops of ink in a predetermined pattern onto the label 26 as controlled by the control unit 28, an arrangement that is commonly referred to as an ink-jet printer. The ink cartridges 48a, 48b can include any combination of colors and inks, but the embodiment shown in FIG. 2 includes a black ink cartridge 48a and a color ink cartridge 48b. Each ink cartridge 48a, 48b can be independently replaced as needed when the supply of ink therein is exhausted. And similar to the automated feeder 18, the printer 24 can be operatively coupled to the control unit 28 by control signal path 77c, as shown schematically in FIG. 6.

An example of a medical image 94 that is compliant with the DICOM standard is shown in FIG. 7. As shown, the medical image 94 is a magnetic resonance image (“MRI”) compliant with the DICOM standard. In this example, the first 794 bytes include information that is collectively referred to as a DICOM header 97, and the remainder of the medical image 94 comprises the image data 99. The example of a medical image 94 shown in FIG. 7 includes a first image 91 and a second image 92, wherein the second image 92 displays a cross section of a human brain taken one level deeper than the cross section displayed by the first image 91. The information within the DICOM header 97 can vary depending on the type of the image within the medical image 94. A representative list of information and parameters to be defined in the DICOM header 97 is included in Part 3 (PS 3.3-2008) of the DICOM standard for various image types, such information to be included in the DICOM header 97 being incorporated in its entirety herein by reference. Examples of information commonly found in the DICOM header 97 include, but are not limited to: the modality used to capture the image appearing in the medical image 94; the image dimensions; the file size; the Transfer Syntax Unique Identifier (“UID”) indicating a type of compression used on the image data 99, if any; the byte order of the image data 99; MRI echo time, the samples per pixel, photometric interpretation, and bits allocated, for example. To minimize the likelihood of the DICOM header 97 getting separated from the image data 99 both the DICOM header 97 and the image data are integrally combined to form the medical image 94 that is compliant with the DICOM standard.

The DICOM standard supports images and other medical output captured by a variety of different medical modalities, including, but not limited to:

BI=Biomagnetic Imaging

CR=Computed Radiography

CT=Computed Tomography

DG=Diaphanography

DM=Digital Microscopy

DX=Digital X-Ray

ES=Endoscopy

HC=Hard Copy

LS=Laser Surface Scan

MG=Mammography

MR=Magnetic Resonance

NM=Nuclear Medicine

OT=Other

PT=Positron Emission Tomography (PET)

RF=Radio Fluoroscopy

RG=Radiographic Imaging (conventional film screen)

RTDOSE (a.k.a. RD)=Radiotherapy Dose

RTIMAGE=Radiotherapy Image

RTPLAN (a.k.a. RP)=Radiotherapy Plan

RTSTRUCT (a.k.a. RS)=Radiotherapy Structure Set

SR=Structured Reporting

TG=Thermography

US=Ultrasound

XA=X-Ray Angiography

XC=external Camera

ECG=Electrocardiograms

The publisher 10, according to an embodiment, can be operatively connected to a communication network 104 such as that shown in FIG. 8. The medical image 94 including image data 99 captured by one or more of the above modalities 101, represented in FIG. 8 as an MRI scanner, can be transmitted over the communication network 104 to be stored in a Picture Archive & Communication System (“PACS”) server 106. The PACS server 106 can be remotely located relative to the MRI modality 101, and not within a close proximity to be directly hardwired into the modality 101, but instead communicates with the modality 101 over the communication network 104.

Although FIG. 8 shows a single modality communication network 104 comprising only the MRI representation of the modality 101, the present application also encompasses a multi-modality 101 environment such as a hospital or other medical care facility comprising two or more modalities 101 such as those listed above operatively connected to communicate with the PACS server 106 over the communication network 104. Specific examples of other such modalities 101 include a medical imaging instrument such as an x-ray machine, CT scanner, and the like; electronic test equipment such as a nuclear magnetic resonance (“NMR”) spectroscope, and the like; and any other device capable of communicating medical image files over a communication pathway that is in communication with the publisher 10, either directly or from a remote location.

Further, communication network 104, as used herein, can include the publisher 10 and, operatively connected to communicate with the publisher 10, at least one of a: computer database storing the medical output in compliance with the medical output formatting standard, a medical modality, and a medical workstation associated with a medical care provider capable of communicating electronic data between each other over a data communication path. There are many types of such networks, including a local area network (“LAN”) such as a token ring network, virtual private network (“VPN”), campus area network (“CAN”), and a wide area network (“WAN”) such as the Internet.

The communication network 104 in FIG. 8 also includes a viewing station 108 operatively connected to retrieve medical image files from the PACS server 106 over the communication network and display the retrieved medical images 94 to medical personnel. A film printer 110 for printing hardcopy reproductions of the image data 99 of medical images 94 can also be provided.

In use, an initiating user or operator initiates a process for publishing a portable computer-readable medium 12 storing a medical image 94 received from a multi-modality environment such as a medical-care facility for example. As mentioned above, the medical image 94 can optionally be part of an examination and optionally any other collection of medical documentation including modality outputs, reports, and all other such related documentation. According to an embodiment, a patient study can be stored on the portable-computer readable medium 12. The study corresponds to an examination of a patient during a given visit, or series of related visits, a series of tests performed in the diagnosis or treatment of a common medical condition, or any other related medical subject matter. The electronic medical images 94 making up one or more studies can be selected to be recorded onto the portable computer-readable media 12. This selection can be made from any of the networked terminals, such as the computer-readable media publisher 10 itself, the viewing station 108, the MRI modality 101, or any other modality (not shown) operatively connected to the network 104 that was used to capture the image data 99 of the medical image 94. As one example, the remotely located PACS server 106 can be queried by the computer-readable media publisher 10 responsive to a request from the operator to determine a quantity of medical image files that collectively form the requested patient study. According to alternate embodiments, the transmission of the medical image files from the PACS server 106 can optionally be initiated, or “pushed,” from the PACS server 106 instead of “pulled” by conducting a query of the PACS server 106.

Initiating transmission of the publication process from the publisher 10 itself can optionally afford such a publication process a higher priority than another publication process initiated via another networked terminal. If the operator initiates the publication process from the publisher 10, it is more likely that that operator is waiting for the published portable computer-readable medium 12 at the publisher 10, and will be inconvenienced by a prolonged wait. However, an operator who initiates a publication process remotely, will likely be preoccupied while awaiting publication of the portable computer-readable medium 12. Thus, the remote operator will be less inconvenienced by a delay (or may have a less urgent need for the published portable computer-readable medium 12) that may result by giving priority to the publication process initiated by the operator at the publisher 10.

When the locally-initiated publication process is initiated at the publisher 10, the remotely-initiated publication process can be prevented from starting before the locally-initiated publication process, can be interrupted and put on hold by the locally-initiated publication process upon reaching a break point in the publication process, can be performed in parallel with the locally-initiated to the extent that the publisher's resources are not diverted from the locally-initiated publication process, or can be slowed to dedicate the resources required by the publisher 10 to accelerate the locally-initiated publication process. Once the locally-initiated publication process is completed the remotely-initiated publication can proceed as normal.

But regardless of how the transmission is initiated, an association in the form of a communication session is established between the portable computer-readable medium publisher 10 and at least one of the host computer storing the medical output (e.g., a PACS server 106), a modality 101 that produced the medical image 94, or any other host computer storing and/or generating the medical image 94. Once the communication session has been initiated, the host computer can transmit the identifying attribute which can be an AE Title according to the DICOM standard or any other identifying attribute, to be received by the publisher in order to enable the publisher 10 to identify a parameter set including at least one parameter to govern at least one functional operation of the publisher 10 during the publication process. The identifying attribute can be received by the publisher 10 early in the communication session, and optionally as the first information transmitted from the host computer and the publisher 10. With the parameter set selected by the publisher 10, the medical image 94 can be received by the publisher 10 when transmitted over the communication network 104 by the host computer. Upon initiation of the transmission, the PACS server 106, modality 101, or other host computer transmits an Application Entity Title (“AE Title”) over the communication network 104 to be received by the publisher 10. The AE Title is an identifier of the host computer (such as the PACS server 106, modality 101, and other networked computerized terminals) connected to the network 104 from where the modality output(s) included in a study can be retrieved to be stored on the portable computer-readable medium. The AE Title can be up to 16 bytes long, and is transmitted over the communication network from the host computer before transmission of the medical output begins to enable a communication session such as a DICOM connection to be established between the host computer and the publisher 10 over the communication network 104. During such a communication session the patient study can be transmitted across the communication network 104 in conformance with the DICOM standard for transferring medical images 94 between devices manufactured by various vendors that produce a variety of digital image formats.

To store the medical image 94 onto the portable computer-readable medium 12, the one or more medical images 94 are received by the computer readable media publisher 10 via the communication network 104 from the remotely located PACS server 106. The received medical images 94 are stored, at least temporarily, as they are received in a buffer memory 88 (FIG. 6) provided to the computer readable media publisher 10, and subsequently stored onto the optical computer-readable medium 12 disposed within one of the optical recording bays 32a, 32b or any other suitable recording bay 78 from at least one of the buffer memories 88a, 88b.

As used herein, a buffer memory 88 refers to any computer-accessible memory, or portion thereof, that can be accessed by the control unit 28 of the publisher 10 to at least temporarily, and optionally permanently or semi-permanently (i.e., store the medical image 94 until erased by an operator or overwritten) store the medical image 94 or other medical modality output. From the buffer memory 88, the medical image 94 is to be subsequently transmitted to an optical recording bay 32 or other recording bay 78 to be recorded onto the portable computer-readable medium 12. For example, the buffer memory 88 can optionally be a portion of one or more hard disk drives provided to the control unit 28 of the publisher 10. The one or more hard disk drives HDD can include the same hard disk drive HDD on which the computer-executable logic or firmware to be executed for controlling operation of the publisher 10 is stored. According to alternate embodiments, the buffer memory 88 can optionally be a computer-accessible memory device other than the hard disk drive HDD, or portion thereof, provided to the recorder 16, the control unit 18, or provided externally of the publisher 10. Again, the medical images 94 transmitted over a communication network to be recorded by the publisher 10 onto a portable computer-readable medium can be stored in the buffer memory 88, at least temporarily, to be subsequently stored on the portable computer-readable medium 12. Thus, the buffer memory 88 can include Random Access Memory (“RAM”) or other volatile memory provided to the publisher 10, or a portion thereof, or any other computer-accessible memory operatively connected to communicate with the publisher. Further, the buffer memory 88 can optionally be local to the publisher 10, and thus, not operatively connected thereto via a communication network.

Due to the large size of most medical image files, a significant amount of time is required to fully receive each complete medical image 94 from the PACS server in the buffer memory 88, and an even longer amount of time is required to receive multiple medical images 94. But a type of portable computer-readable medium 12 to be used to store the medical image 94, and optionally at least a portion, if not all of the label information to be included within a label region on the non-data recording surface of the optical computer readable medium can be extracted from the DICOM header 97, AE Title, or other data received early during, or even before the transmission of the medical image 94. Thus, the appropriate portable computer-readable medium 12 can be selected, and optionally transported to the recording bay 32, printer 24, or both without operator intervention so that recording of the medical image 94 on the portable computer-readable medium 12, printing the label information on the portable computer-readable medium, or both can be performed in parallel with receiving the medical image over the communication network 104. Selecting the appropriate type of the portable computer-readable medium can occur before receiving the transmission comprising the medical output is complete, and optionally at an early stage of the communication session.

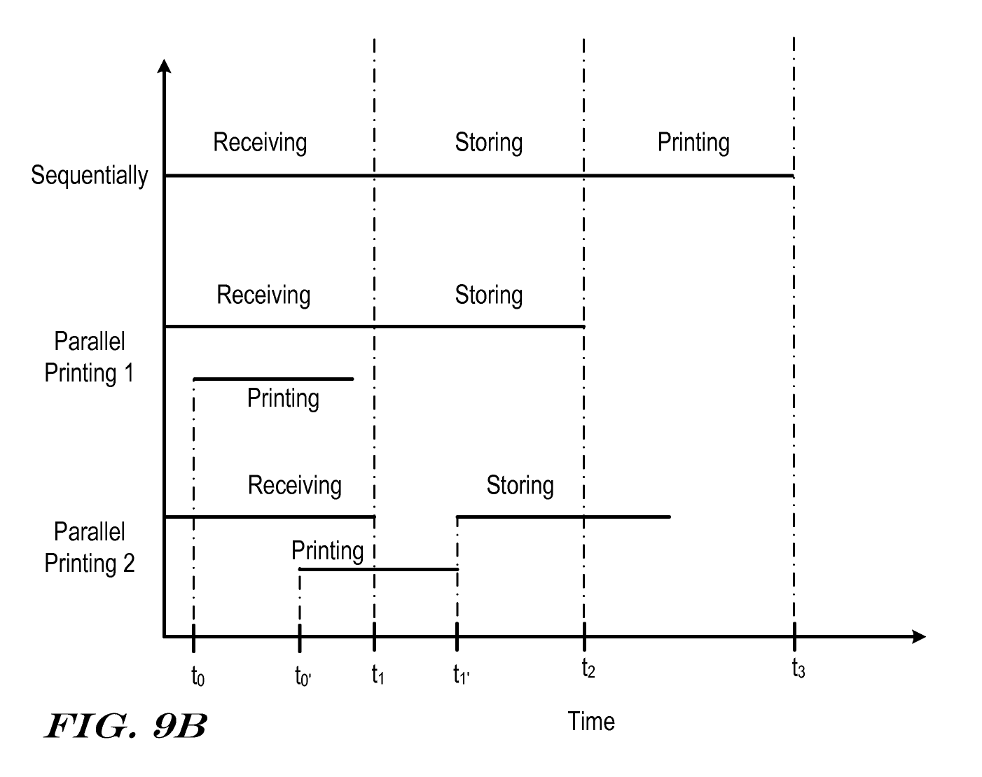

Responsive to selecting the appropriate type of the portable computer-readable medium 12, the appropriate type of portable computer-readable medium is transported (e.g., with the automated feeder 18) to a destination such as one of the recording bays 32a, 32b for storing the medical output onto the portable computer-readable medium 12. Again, transporting the appropriate type of portable computer-readable medium 12 can be accomplished automatically, without operator intervention. The publisher 10 can also optionally be provided with an instruction to autorecord upon receiving such a command from the operator. As shown in FIG. 9A, the type, format, quality or other feature of the portable computer-readable medium 12 can be determined at an early stage of, or before the transmission of the medical image 94 begins. The transmission of the medical image 94 and receiving of the medical image 94 by the publisher 10 over the communication network 104 is represented by line 41. For example, the job profile corresponding to the AE Title received before actual transmission of the medical image 94 begins can allow the publisher 10 to select the format (e.g., CD, DVD, Blue-ray Disc, etc. . . . ) of the portable computer-readable medium 12 to be used to store the study comprising the medial image 94. The embodiment where selection and transportation of the appropriate computer-readable medium 12 begins before the transmission of the medical image 94 (e.g., when the selection is made in response to receiving the AE Title) over the communication network 104 are represented in the timing diagram of FIG. 9A by broken line 47. Other embodiments can extract the information needed to select the portable computer-readable medium 12 from the medical image 94 itself (e.g., from the header portion 97) after the transmission of the medical image has begun. Such embodiments of the selection are represented by solid line 49.

The selection and transportation process is conducted in parallel with the receiving of the medical image 94 over the communication network 104 from the remotely located host computer. The timing of the embodiments of the selecting and transporting of the portable computer-readable medium is represented by lines 47 and 49 in FIG. 9A, include determining the appropriate portable computer-readable medium 12, and the subsequent transportation of the appropriate computer-readable medium 12 selected to the printer 24, recording bay 32, or both. At time t₁, when the selection and transporting of the portable computer-readable medium 12 is complete, a subsequent step can also optionally be conducted in parallel with the receiving of the medical image 94 over the communication network 104. For a parallel printing embodiment, the timing of which is represented by line 51, much of the label information that is to appear in the label region on the optical computer-readable medium 12 is received substantially at a beginning of the transmission of the medical image 94 to the computer readable media publisher 10. This information received at the beginning of the transmission allows the label information to be prepared (e.g., extracted from the DICOM header 97 embedded as part of the medical image 94 and formatted, referenced to the AE Title) to appear in the label region from the header portion 97 of the medical image 94. According to the parallel printing embodiment, which is described below in further detail with reference to FIG. 9B, printing can commence in parallel with the receiving of the medical image 94, optionally followed by the subsequent transportation of the portable computer-readable medium 12 to the recording bay 32 at time t₂, when printing of the label information has been completed. Upon reaching the recording bay 32 the portable computer-readable medium 12 enters the initialization phase during which the publisher 10 conducts a spin-up to recognize the portable computer-readable medium 12 and prepare to record the medical image 94 thereon at time t₄. Following completion of initialization, the storing of the medical image 94 onto the portable computer-readable medium 12 commences at time t₅, optionally also in parallel with receiving the medical image represented by line 41.

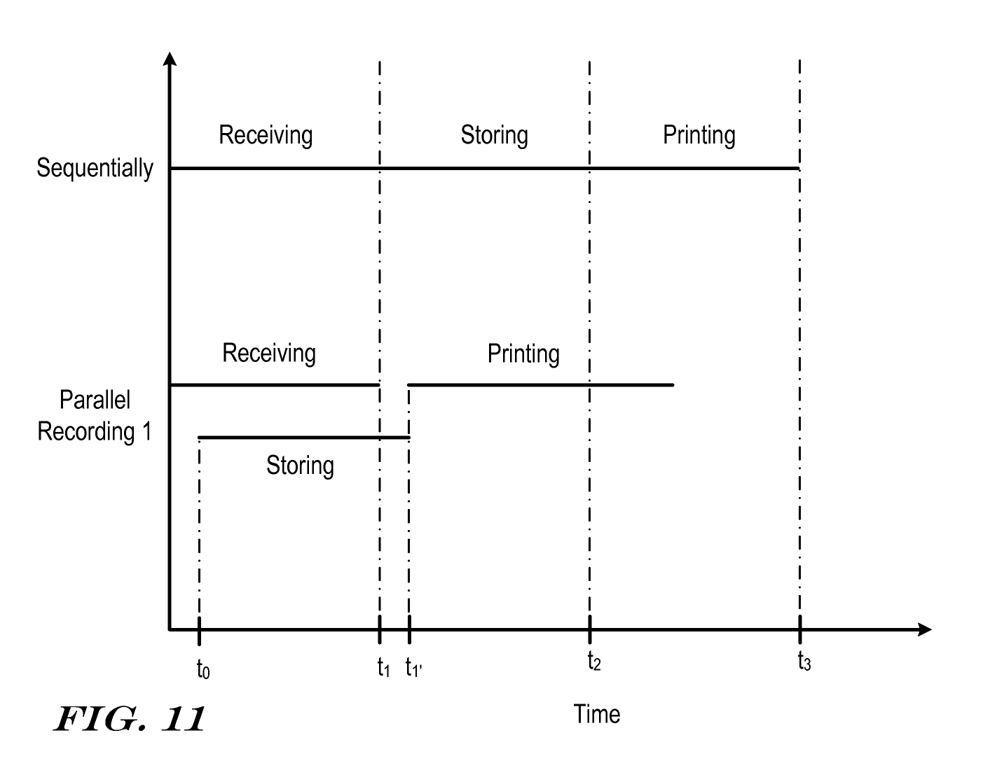

According to another embodiment, referred to as parallel recording and represented by timing line 54, upon selecting the appropriate portable computer-readable medium 12 the publisher can optionally transport it to the recording bay 32 without first being transported to the printer 24, and again, without operator intervention. At time t₁ when the selecting/transporting is complete, initialization can begin, and can be carried out in parallel with the receiving of the medical image 94 over the communication network 104. And just as before, following completion of the initialization at time t₃, storing of the medical image 94 onto the portable computer-readable medium can begin. For such an embodiment, it should be apparent that storing the medical image 94 onto the portable computer-readable medium 12 can not be completed prior to completion of the receiving of the medical image over the communication network 104. Thus, for the parallel recording embodiment the printing of label information, if desired, is to be performed in series with the storing of the medical image 94 onto the portable computer-readable medium 12. The parallel recording embodiments are discussed in further detail below with regard to FIG. 11.

As illustrated by the timing diagram of FIG. 9B, the time to first disc can be minimized by printing at least a portion of the label information on the optical computer-readable medium 12 in parallel with the receiving of the medical image 94 from the PACS server 106. Receipt of the medical image file by the computer readable media publisher 10 begins at a time indicated by the origin, or where the ordinate intersects the abscissa. If receiving the medical image file, recording the medical image 94 onto the portable computer-readable medium and applying the label information onto the portable computer-readable medium as depicted by the top line in FIG. 9B, publication of the portable computer-readable medium is not complete until time t₃.

Instead, upon receiving the initial portion of the transmission including at least a portion of the label information at time t₀, as shown by the “Parallel Printing 1” lines of FIG. 9B, the process of printing or otherwise applying the label information onto the portable computer-readable medium can begin even before all of the medical image 94 has been received, which occurs at time t₁. Since printing or otherwise applying the label information in this example is complete before time t₁ when the complete medical image 94 has been received, the publication process can immediately continue to the storing of the medical image 94 from the buffer memory 88 to the portable computer readable medium 12.

Any additional label information to be applied to the portable computer-readable medium 12 but received later in the transmission (such as label information embedded in a second or subsequent medical image for example) may delay the start of the application of the label information to the label region of the portable computer-readable medium 12 until time t_{0′}. This scenario is shown by the lowest lines labeled “Parallel Printing 2” in FIG. 9B. Once application of the label information eventually begins, however, it is not interrupted but allowed to finish before the portable computer-readable medium 12 is transported to the appropriate optical recording bay 32 to have the medical image 94 stored thereon. Due to the extended delay experienced by the late receipt of the label information the printing step extends beyond completion of the “Receiving” step, and thus delays the “Storing” step from t₁ to t_{1′}, as shown. Thus, from time t₁ to time t_{1′} in FIG. 9B the storing of the medical image 94 onto the portable computer-readable medium 12 is delayed while printing the label information is completed. The length of time required for the publication process to be completed is shortened by about the length of time that the “Printing” step is being conducted at the same time as the receiving of the medical output. For the “Parallel Printing 2” example of FIG. 9B the publication process can be shortened by about the time from t_{0′} to t₁.

According to alternate embodiments, the label information can be received early enough to enable parallel application of the label information on the computer readable medium with the receiving of the medical image file over the communication network 104 by initially querying a host computer storing such information in a database, for example, or by querying a host computer such as the PACS server 106, for example. Querying the PACS server 106 can initiate transmission of the medical image 94 from the PACS server over the communication network 104, thereby transmitting the header portion 97 from which the label information can be extracted. For some embodiments, receiving and even applying the label information within the label region on the optical computer-readable medium is completed before receiving the transmission comprising the medical image 94 is completed. The query of the database storing the label information over a communication network allows the label information to be retrieved before transmission of the medical image 94 begins. For such embodiments where a plurality of medical images 94 are to be stored on the computer-readable medium 12, the query can optionally result in the retrieval of label information associated with the plurality of medical images 94 to be received and later stored on the portable computer-readable medium 12. Thus, when transmission of the medical image(s) 94 over the communication network 104 to be received by the computer-readable media publisher 12 begins in response to such a query, the required label information can be retrieved to permit the computer-readable media publisher 10 to at least begin to print or otherwise apply the label information in parallel with receiving the medical image(s) 94. As discussed above, the label information can include at least information identifying a number of optical computer-readable media required to store all of the plurality of medical image files to be stored. Further, the label information can include a label such as a disc number to identify the order of the optical computer-readable media in a sequence to be produced.

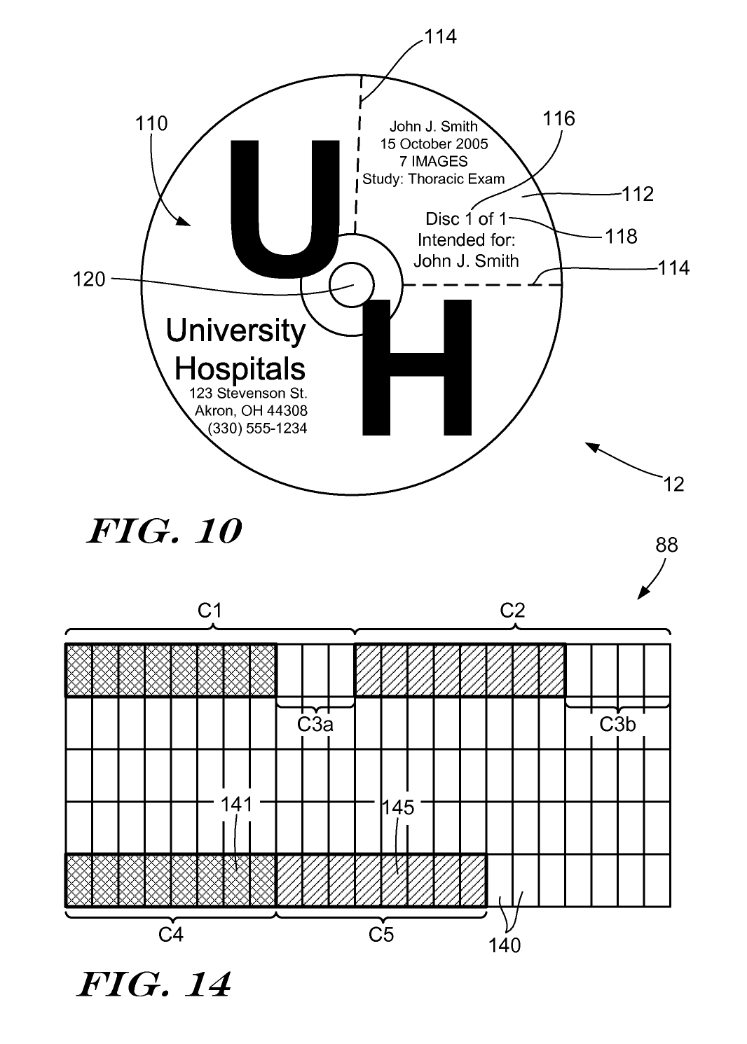

For embodiments including a CD, DVD, Blu-ray Disc or other optical portable computer-readable medium 12 such as that shown in FIG. 10, the label information can be applied thereto by printing it in ink (or other printing media to be applied to the computer-readable medium 12 as discussed above) within the label region 112 (illustrated between broken lines 114 in FIG. 10) on a non-data side 110 of the optical computer readable media 12. Although the following discussion refers specifically to the use of “ink” to print the label content for illustrative purposes, it is equally applicable to other printing media. The ink, such as that used to print the stylized mark “UH” can be selected as a rapid drying ink that dries quickly enough to dry between a time when the ink is applied to the computer-readable medium 12 and a time when the optical portable computer-readable medium 12 is initially spun during spin-up as a preliminary step in storing the medical image 94 thereon. Thus, once the ink is applied, it is dry enough to resist being blurred, smeared or otherwise disturbed under the centrifugal force imparted thereon when the optical computer-readable medium is rotated during storage of the medical image 94.

In preparing the label information to be applied to the portable computer-readable medium 12, the publisher 10 locally stores a plurality of job profiles, wherein each job profile is associated with an AE Title. When an AE Title is received by the publisher 10 to establish a communication session with the host computer, the publisher 10 utilized the job profile associate with the AE Title that was received. Each job profile includes at least one parameter for defining a formatting scheme for the label information to be applied within the label region on the computer-readable medium. The job profiles can also include a parameter that identifies the portable computer-readable medium 12 that is to be selected for storing the medical output, and any other parameter to govern the publication process. The label information is to be applied within the label region according to the formatting scheme defined by the job profile. Examples of parameters that can optionally be included in a job file include, but are not limited to: a required archive life of the portable computer-readable medium 12 to be used for storing the medical output; a recording speed required or desired for storing the medical output onto the portable computer-readable medium 12; a quality of a label (print quality, print speed, gloss level, including marketing material or other graphical content for a particular intended recipient who is not affiliated with the medical care provider, etc. . . . ) to be applied to the portable computer-readable medium; and a maximum cost of the portable computer-readable medium 12 to be used for storing the medical output. Further, the job profile can optionally define a formatting scheme for the label information to be applied within the label region 112 on the portable computer-readable medium 12. The job profile can define, among other labeling details for each portable computer-readable medium 12 to be labeled, at least one formatting scheme for the label information. The labeling scheme can include a speed format including minimal printing requirements to minimize a time required to complete printing the label information within the label region. For example, a speed formatting scheme may require at least one of: the disc number 116 and, optionally the total number 118 of discs in a series be printed; include label information that minimizes the amount of ink or other printing medium applied to the label region to minimize drying time required to minimize distortion of the label information during the recording of the medical output onto the portable computer-readable medium 12, and the like. Graphical and other aesthetic features of the label information (such as the stylized “UH” in FIG. 10) can optionally be omitted from the speed profile to minimize the time required to print all the label information. Other examples of parameters defining aspects of the publication process included in the parameter set of the speed profile include at least one of: a fastest available printing mode (e.g., minimal print resolution and/or other quality in exchange for maximum printing speed) to be used to apply the label information, a monochromatic ink or other printing medium for printing the label information, a limit of one study to be stored on the portable computer-readable medium 12, a date, patient name, number of images, and the like . . . , all in standard text instead of graphical label information, and the like.

The labeling scheme can include a standard format instead of the speed format. Unlike the speed format, the standard format does not significantly restrict the printing requirements of label information. The time required to complete printing of the label information formatted according to the standard format is longer than the time required to complete printing the label information formatted according to the speed format. For instance, the standard format may include all text as well as the graphical elements in FIG. 10, in addition to optional marketing material, or other label information that is independent of the contents of the portable computer-readable medium 12 on which it is applied. According to alternate embodiments, the label information can optionally be associated with the contents of the portable computer-readable medium 12 on which it is to be applied.

The job profile may be stored locally on the computer-readable media publisher 10, or can optionally be retrieved from a database such as the PACS server 106 in response to a query request. The job profile can optionally govern the preparation of the label information to appear in the label region to balance the optical portable computer-readable medium 12 when being rotated to store the medical image 94 thereon. For example, a layout of the label information can be created to substantially balance a distribution of ink (or other printing medium) applied to the optical computer-readable medium 12 during printing of the label information. Balancing the ink or other printing medium distribution minimizes an unbalanced condition experienced by the optical computer-readable medium 12 when rotated during writing of the medical image 94 onto the optical computer-readable medium 12. In FIG. 10, the “U” and the “H” combined have a center of gravity located approximately at the center 120 of the optical portable computer-readable medium 12. Likewise, the “University Hospitals” and address text is distributed opposite of the patient and other label information in the label region 112 relative to the center 120. Thus, when the portable computer-readable medium 12 is spun within the recording bay 32 during spin-up and recording it will experience minimal imbalance.

To further speed publication of portable computer-readable media, other embodiments can optionally utilize a multi-core processor provided to the control unit 28 of the computer-readable media publisher 10 to initiate and control recording the received medical images 94 onto the portable computer-readable medium 12 while contemporaneously receiving the medical image 94. Separate cores or processing units of the multi-core processor can be utilized so that the processes of receiving and storing the medical image 94 can be performed in parallel instead of in series. The control unit 28 ensures that the data continues to be received by the computer-readable medium publisher 10 at a maximum transfer rate while the process of recording the received medical image file to the portable computer-readable medium 12 is performed at the same time to at least partially overlap. By performing the receiving process and the recording process in parallel, the time to first disc is reduced thereby resulting in a corresponding increase in throughput. The reduction in time to first disc is directly related to the amount of transferred data that may be recorded to the portable computer-readable medium 12 prior to completion of the data transfer process. The term “time to first disc” refers to a measure of time from the initial transfer of the medical image 94 data to production of a recorded disc or portable computer-readable medium 12. The term “throughput” refers to the number of recorded discs or portable computer-readable medium 12 that may be published within a specific period of time, for example, one (1) hour. A decrease in the time to first disc generally results in an increase in throughput. Embodiments of the present computer-readable media publisher can achieve a throughput of at least 30 discs/hour.

Instead of applying the label information onto the portable computer-readable medium 12 in parallel with receiving the medical image 94, recording the medical image 94 onto the portable computer-readable medium 12 can be performed in parallel with receiving the medical image 94. With reference to the timing diagram of FIG. 11, sequentially receiving medical image files, printing label information and storing the received medical images 94 as indicated by the line labeled “Sequentially” is time consuming. Each previous process is completed before the next one starts.

By storing the medical images 94 contemporaneously with receiving them, also referred to as conducting these two processes in parallel, the time to first disc can be minimized. As shown, once a suitable portion of the medical image 94 has been received in the buffer memory 88 at time t₀, the process of writing the medical image 94 onto the portable computer-readable medium 12 is initiated. The delay between the start of the receiving process and the initiation of the storing process at time to is sufficient to prevent the storing of the medical image 94 to catch up with the receiving of the medical image 94, which is referred to as an underrun condition. Since recording the medical image 94 onto the portable computer-readable medium 12 and applying the label information to the portable computer-readable medium 12 can not be performed at the same time, the application of label information onto the portable computer-readable medium 12 commences immediately following completion of the storing process at time t_{1′}.

The medical image file can be received in a DICOM standard compliant file format, and stored on the portable computer-readable medium 12 in the DICOM standard compliant file format without an intermediate conversion into a different format. In this manner, the medical image 94 can be stored in the buffer memory 88 in a DICOM standard compliant format and subsequently written from the buffer memory 88 onto the portable computer-readable medium 12 in a first-in-first-out order. Thus, the first portion of the medical image 94 to be received is the first to be stored onto the portable computer-readable medium 12. Likewise, the second portion of the medical image 94 to be received is the second portion of the medical image 94 to be stored on the portable computer-readable medium 12.

Embodiments of the present method and apparatus can optionally store a study comprising a plurality of medical images 94 across a plurality of portable computer-readable media 12. For such embodiments, storage of the medical image(s) 94 on a first portable computer-readable medium 12 is completed while subsequent medical image(s) 94 are being received in the buffer memory 88. Once storage of the medical image(s) 94 on the first portable computer-readable medium 12 is completed, the subsequent medical image(s) 94 can be stored on the second portable computer-readable medium 12.

In another embodiment, the computer-readable medium publisher 10 comprises a file system, that can optionally be included as part of an operating system of the computer-readable medium publisher 10. The file system is operable to structure storage of the medical output such as medical images 94 in the buffer memory 88. Further, the computer-readable medium publisher 10 can include an organizational component including computer-executable logic that, when executed, is operable to name, or at least establish a link to a name in compliance with the DICOM and/or PDI standards, or other standard medical imaging or medical output format as the medical images 94 are received. The file system can also organize the incoming medical image files in the buffer memory 88 provided to the computer-readable medium publisher 10 in preparation of storing those medical image files onto a portable computer-readable medium. Conventional file systems name and subsequently organize the received files to be stored onto a portable computer-readable medium 12 only after all of the files have been completely received within the buffer memory 88. Such file systems actually make a temporary copy of the received files in the buffer memory 88 or another memory provided to the computer-readable medium publisher 10, organized and named as those files are to appear on the portable computer-readable medium 12. Such a method and system for organizing received files is time consuming because a copy of each of the received files is created, and computer-resource intensive (particularly bus intensive requiring vast internal communications) for the same reason.

The present file system, in contrast, includes computer-executable logic stored in a portion of the buffer memory 88 not used for storing received medical images 94 or another computer-accessible memory of the computer-readable medium publisher 10 that is executable by the central processing unit to conduct a file management process. The file management process includes a “DICOMDIR generation” step and a “file layout” step, optionally performed in real-time, as the medical image files are received and stored in the buffer memory 88.

The DICOMDIR is a file to be stored in a root, or at least upper-level directory on a PDI-compliant portable computer-readable medium 12. The PDI-compliant portable computer-readable medium 12 stores the medical images 94 and related content in a medical output formatting standard, and also optionally a viewer or other suitable media presentation software for opening the medical output that is stored either compressed or uncompressed on the portable computer-readable medium 12. Such a viewer or other media presentation software can be compatible with a variety of different clients to enable wide distribution of the medical output to be viewed, listened to, or otherwise used by a variety of different end users using different hardware. For example, the medical image 94 is to be compatible for use with a display device such as a personal computer, a medical viewing station, a report reader, print composer and a media importer. The DICOMDIR describes the layout of the medical images 94 and other medical output stored on the portable computer-readable medium 12, and optionally other information taken from the DICOM header 97 such as patient name, study ID, etc. . . . Thus, the DICOMDIR is analogous to a table of contents of the portable computer-readable medium 12.

Responsive to receiving a medical image 94 or related content in the buffer memory 88 to be recorded onto the portable computer-readable medium 12, the control unit 28 begins the DICOMDIR generation step by creating a partial DICOMDIR file including the information corresponding to the medical image 94 received. This can occur even while contemporaneously, and in parallel with receiving a second medical image 94 to be included on the portable computer-readable medium 12. The DICOMDIR file can be updated in real time to include any additional information as the subsequent medical images 94 are received, or optionally can be updated once all medical output has been received. Thus, the DICOMDIR can be gradually generated and completed substantially immediately prior to recording the received medical images 94 onto the portable computer-readable medium 12. According to alternate embodiments, the received medical images 94 can optionally be recorded onto the portable computer-readable medium 12 in parallel with receiving said medical image files as described above, in which case the DICOMDIR file can be stored on the portable computer-readable medium 12 after, or near the completion of the storing of the medical images 94 onto the portable computer-readable medium 12.

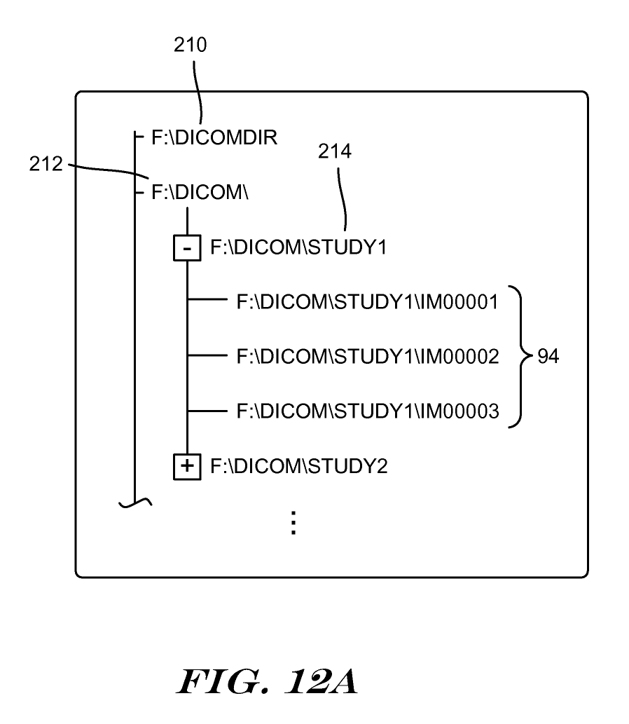

For the medical output to be stored on the portable computer-readable medium 12 in compliance with the DICOM standard (e.g., Part 10 of the DICOM standard, which is incorporated in its entirety herein by reference), the portable computer-readable medium 12 is to be organized with the DICOMDIR file and a DICOM directory at the root level of the portable computer-readable medium 12. The medical output and other content can be stored under the DICOM directory, and optionally organized into subfolders under the DICOM directory. An example of such an arrangement can be seen in FIG. 12A. As shown, the DICOMDIR file 210 is located at the root level of the portable computer-readable medium 12, which is shown as F:\ in FIG. 12A. The DICOM folder 212 is also located at the root level of the portable computer-readable medium 12. Under the DICOM folder 212 is a Study1 subfolder 214 in which the medical images 94 or any other medical output can be stored. The Study1 subfolder 214 has been expanded to show the medical images 94 stored therein. Although only two subfolders at the F:\DICOM\level are shown, it is to be noted that additional subfolders can be provided at that level, and optionally at the F:\DICOM\STUDY1 level, F:\DICOM\STUDY2 level, or even further interior levels. Further, other requirements such as an eight-character limit to the file names located under the DICOM folder or subfolder thereof can also be observed.

The file-system layout step comprises storing the received medical images 94 within the buffer memory 88 in a manner to eliminate the need to create a temporary copy of the received medical images 94 as a precursor to storing those medical images 94 onto the portable computer-readable medium 12. A copy of the medical images 94 in the buffer memory 88 can be copied to another location in the buffer memory 88 and those copies arranged as they are to be stored on the portable computer-readable medium 12. According to alternate embodiments, however, the file layout step can be conducted without storing both the medical images 94 and a copy thereof as part of a “pre-ordering” step. According to this embodiment, the medical images 94 are received and stored, at least temporarily, in the buffer memory 88 in the order they were received as shown in FIG. 12B. As each medical image 94 is received they are assigned a name by the publisher 10. By assigning each medical image 94 a name the publisher 10 can utilize the known names to read the medical images 94 from the buffer memory 88 to be stored on the portable computer-readable medium 12.

Further, a referential link 121 such as a symbolic link, hard link, and the like can be established between the medical image 94 and a file 122 in a recording queue 124. The referential link 121 can optionally be an intangible relationship, such as a text file listing the medical images 94 and their counterpart to be stored on the portable computer-readable medium 12, or it can be a correlation similar to a hyperlink between linked files. Regardless of the form of the referential link 121, the files 122 recorded onto the portable computer-readable medium 12 will be the same as their counterpart medical images 94 in the buffer memory 88, but will be renamed and organized in compliance with the DICOM standard, PDI standard, or both. In this way, the need to generate duplicate copies of each medical image 94 as a preparatory step to recording those medical images 94 onto the portable computer-readable medium 12 is eliminated.

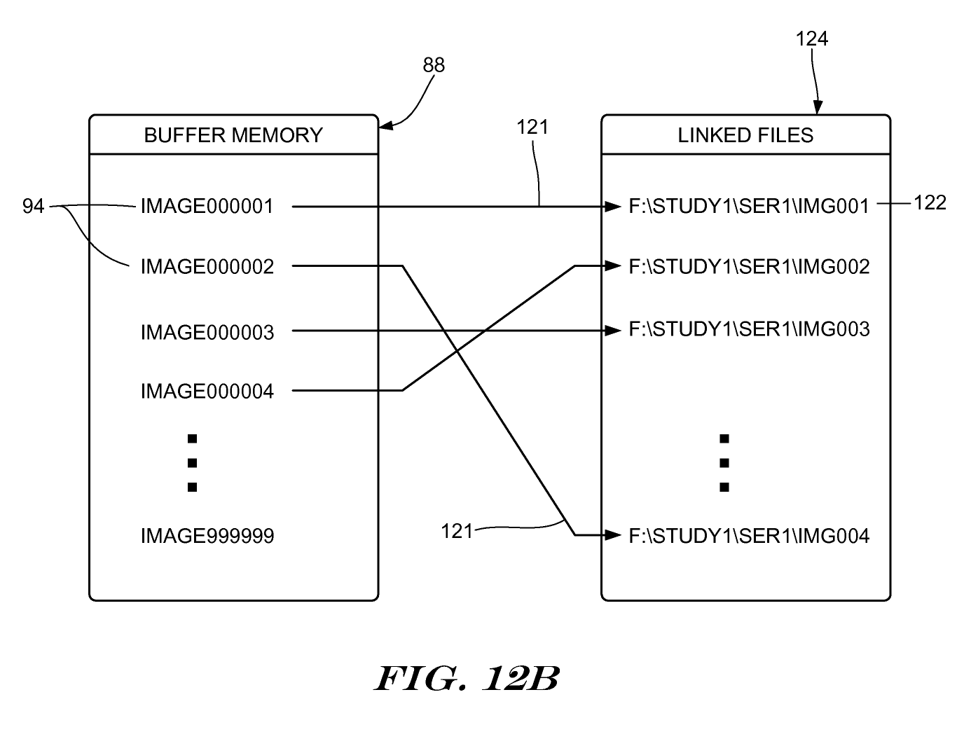

According to an alternate embodiment a “pre-ordering” step can be performed in addition to the creation of the links 121. For such an embodiment, embedded data (such as data from the DICOM header 97) in the received medical images 94 can be evaluated to organize the medical images 94 into suitable folders as shown in FIG. 13. As shown, the medical images 94 are placed in folders 125 corresponding to the modality utilized to capture the image data 99 of each medical image 94, but can alternately be grouped according to any logical grouping such as in studies, where a plurality of different medical modalities were used to collect the medical output during the study for example. Thus, storing the medical images 94 onto the portable computer-readable medium 12 includes selecting the folders 125 to be stored, and storing the medical images 94 therein in groups on the portable computer-readable medium 12 according to the referential links 121 relating the folders 125 in the buffer memory 88 to the desired locations on the portable computer-readable medium 12 where the folders 125 and their contents are to be stored. Each medical image file can be named in compliance with the DICOM standard, PDI standard or both when stored on the portable computer-readable medium 12.

For any of the embodiments including the referential links 121, when a medical image 94, group of medical images 94, or any other medical output is to be stored onto the portable computer-readable medium 12, the publisher 10 can retrieve the medical image 94 from the buffer memory 88 with reference to the referential links 121. In other words, for the example shown in FIG. 12A, when the publisher 10 stores the medical image 94 assigned the name IMAGE000004 from the buffer memory 88 onto the portable computer-readable medium 12, that medical image 94 will be assigned the name IMG001, and stored at F:\STUDY1\SER1\ on the portable computer-readable medium 12. Further, the medical image IMAGE000004 can be retrieved from the buffer memory 88 by following the referential link 121 relating IMAGE000004 in the buffer memory 88 to IMG001 in the appropriate folder on the portable computer-readable memory 12.

To further minimize the time to first disc, and thereby maximize throughput, a compression algorithm can optionally be used to compress one or more medical images 94 before being stored onto the portable computer-readable medium 12. From the portable computer-readable medium 12, the compressed medical output can be uncompressed for subsequent use by a compatible media presentation software executed by suitable computer hardware to present the medical output to the user. Compressing the medical images 94 before storing them on the portable computer-readable medium 12 allows more medical images 94 than would be possible in their native, uncompressed state to be stored on the portable computer-readable medium 12. The DICOM standard, including Part 3 (PS 3.3-2008) which is incorporated in its entirety herein by reference, supports use of various compression algorithms to minimize the size of each medical image 94 to be stored on the portable computer-readable medium 12. Examples of such supported compression algorithms include 8, 16 and 24-bit J2K Lossless and Lossy compression methods, 8, 16 and 24-bit JPEG Lossless and Lossy compression methods, and 8, 16 and 24-bit Run Length Encoding compression methods. Further, despite the time required to conduct the compression, either locally or remotely at the host computer, storing the compressed medical output on the portable computer-readable medium 12 can require less time than storing the medical output without first being compressed on the portable computer-readable medium 12 because of the considerable time saved to store the smaller medical output onto the portable computer-readable medium 12. Under such circumstances, a delay incurred by compressing the medical output is less than a difference between a time required to the store medical output uncompressed on the portable computer readable medium 12 and a time required to store the medical output compressed on the portable computer-readable medium 12.

The publisher 10 can transmit an instruction instructing the host computer to conduct the compression, or can compress the medical output locally after having received it over the communication network 104. Determining whether to compress the medical output at the host depends on whether the host supports the predetermined compression to be requested by the publisher 10. If the host supports the desired compression, the instruction can be transmitted to the host and the compressed medical output received over the communication network 10 responsive to such a determination that the predetermined compression scheme is supported by the host computer. If the publisher 10 receives an indication that the host supports the desired compression, the publisher 10 can optionally transmit a request for compression automatically, without operator intervention.

To compress a medical image 94 according to one embodiment, compression of the medical image file according to a DICOM compliant compression method is initiated to convert the medical image file into a compressed medical image file. The compressed medical image 94 is stored, at least temporarily, in the buffer memory 88 operatively connected to the computer-readable medium publisher 10 to be subsequently stored onto the portable computer-readable medium 12. To initiate compression of the medical image 94, a request to compress the medical image 94 can be transmitted over the PACS network 104 (or other type of communication network) to a host computer, such as the PACS server 106 for example, that is associated with a database storing the medical image 94 to be compressed. Such a request to compress can optionally request the PACS server 106 or other host computer to compress the medical image 94 before being transmitted over the PACS network 104 to be received by the computer-readable medium publisher 10 and stored in the buffer memory 88. According to such embodiments, the PACS server 106 can include a computational architecture that can compress the medical image 94 faster than the computer-readable medium publisher 10. The medical image 94, once compressed, can be transmitted over the PACS network 104, stored in the buffer memory 88 and subsequently stored on the portable computer-readable medium 12 faster than the uncompressed medical image 94 can be. Thus, despite the time requirement to compress the medical image 94 at the PACS server 106 before transmitting it over the PACS network 104, the subsequent operations resulting in storage of the compressed medical image 94 onto the portable computer-readable medium 12 can be shortened enough to make the total publication time shorter than it would have been without performing the compression.

According to alternate embodiments, initiating compression of the medical image 94 can include receiving with the computer-readable medium publisher 10 the medical image 94 in an uncompressed format from the PACS server 106 over the communication network 104. Subsequent to receiving the medical image 94 in the uncompressed format over the PACS network 104, the medical image 94 can be compressed with a compression component of the computer-readable medium publisher 10 to be saved in the buffer memory 88 in the compressed format. According to alternate embodiments, the medical image 94 can be received uncompressed over the PACS network 104, stored uncompressed in the buffer memory 88, and subsequently compressed while the medical image is being received or after the medical image is received, locally by the compression component of the computer-readable medium publisher 10 prior to being stored on the portable computer-readable medium 12. locally compressing the medical output can include compressing portions of the medical output as those portions are received substantially in real time, and storing the portions of the medical output as compressed portions, at least temporarily, in at least one buffer memory 88a, 88b. In either instance, storing the compressed medical image 94 on the portable computer-readable medium 12 can optionally require less time than would be required to store the uncompressed medical image 94 on the portable computer-readable medium 12. For yet other embodiments, the length of the delay incurred by locally compressing the medical image file is less than a difference between a time required to store the medical image 94 uncompressed on the portable computer readable medium 12 and a time required to store the medical image 94 compressed on the portable computer-readable medium, again resulting in a shorter overall publication time. For any of the embodiments, initiating compression of the medical image 94 can be done automatically, without operator intervention once the publication process has been initiated.

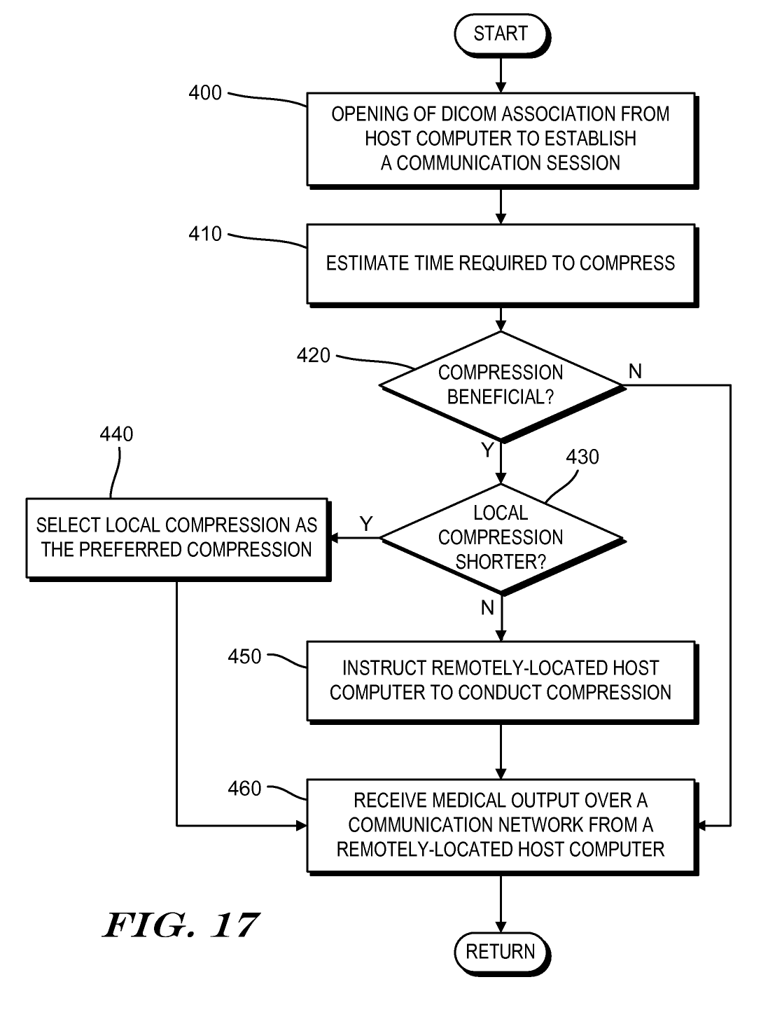

According to yet other embodiments, where compression of the medical image 94 occurs can be adapted depending on the compression resources available for each job, and optionally on other conditions that can affect the delay, if any, that will result in the completing publication of the portable computer-readable medium 12. As shown in FIG. 17, the AE Title or other identifying attribute transmitted over the communication network 104 at step 400 to identify the host computer, which in the present example is the PACS server 106. Whether compression will shorten the overall publication process, as determined at step 420, can be predicted by first determining whether the PACS server 106 is storing the medical image 94 in an uncompressed format, and if so, estimating an amount of medical output to be compressed at step 410. If the medical image is already stored in a compressed format, then there is no need to compress it and the publication process can proceed to the transmission of the compressed medical image over the communication network 104.

If the medical image is stored uncompressed, however, the estimation of the amount of medical output can be accomplished by determining a number of medical images 94 or quantity of other medical output to be received during an initial stage of the communication session for example. It can also be determined whether the size of the medical image, when compressed, will be larger than a minimum amount of data required to be stored on the portable computer-readable medium 12. Media such as DVDs have a minimum recording threshold requiring a minimal amount of data to be recorded thereon. If the compressed medical image is significantly smaller than this minimal amount, an overall time saving will not be realized because additional data must also be stored on the DVD to meet this minimum threshold. But if the medical image is uncompressed and the size of the medical image is sufficiently large that, even compressed, it will exceed the minimal amount of data required for the portable computer-readable medium, then at step 420 it can be determined that compression will shorten the overall duration of the publication process. To evaluate the size of the total size of the medical image(s) to be compressed, the number of medical images 94 or quantity of other medical output can optionally be extracted from the DICOM header 97, or by conducting a query of the PACS server 106 over the communication network to determine a number of medical images or other quantification of the medical output before transmission of the medical output over the communication network 104 begins.

According to alternate embodiments, predicting that compression of the medical image 94 will shorten the duration of the publication process can include estimating the time required to store any backlogged jobs already received by the publisher 10 over the communication network 104 but not yet stored on a portable computer-readable medium 12. For example, the computer-readable medium publisher 10 can submit a plurality of requests to receive medical output to be stored on different portable computer-readable media as separate jobs, and receive the medical output as several different jobs. If the jobs are received faster than they can be stored onto portable computer-readable media 12, these received jobs can become backlogged, and can require a significant amount of time to permit the publisher 10 to store the computer output on the portable computer-readable media. Due to this delay, even if a request for the PACS server 106 to transmit a current medical output is submitted, the publisher 10 will not process this current medical output soon due to the backlogged jobs in front of the current request. Thus, the publisher 10 can transmit a request for the PACS server 106 to compress the medical output, even if requesting the compression to be performed by the PACS server would ordinarily prolong the publication process, or take longer than the publisher 10 to perform the compression of the medical output without the backlog of jobs. Thus, while the backlog of jobs is being stored on their respective portable computer-readable media 12 by the publisher 10, the PACS server 106 will likely be able to complete a significant portion, if not all of the compression of the medical output. The medical output can then be transmitted over the communication network 104, received by the publisher 10 and subsequently stored on the portable computer-readable medium 12 in a compressed format without incurring a delay to wait for the publisher 10 to compress the medical output once the backlog of jobs is resolved. The transmission, receipt and storage of the medical output on the portable computer-readable medium in the compressed format can shorten the time required to complete publication of the portable computer-readable medium 12 relative to the time required for publication if the publisher 10 was to compress the medical output locally after resolving the backlog of jobs.

Accordingly, the publisher 10 can recognize when there are a sufficient number of backlogged jobs that have been received over the communication network 104 ahead of a medical image 94 currently being requested to justify a request for the PACS server or other host computer to conduct the compression remotely from the publisher 10. Once a predetermined number of backlogged jobs are detected, the publisher 10 can request the PACS server to compress the requested medical image 94 even if the publisher 10 would be able to compress the medical image 94 quicker than the PACS server 106 without the backlog of jobs.

If the overall publication of the portable computer-readable medium 12, including storage of the estimated amount medical output onto the portable computer-readable medium 12, will be extended by compressing the medical output relative to the publication process utilizing uncompressed medical output, then it is determined at step 420 that compression will not be beneficial, and the publication process can proceed without first compressing the medical output. If, however, at step 420 it is determined that compressing the medical output to be stored on the portable computer-readable medium 12 will shorten the overall publication process, then the publication process proceeds to determine whether local compression or compression by the host computer will shorten the overall publication process to a greater extent.

To make the determination whether local compression or compression of the medical output by the PACS server is shorter at step 430, the predicted time required for compression at the host computer is to be compared to with the predicted time required for the medical image 94 to be compressed locally. According to alternate embodiments, it can be determined whether the PACS server 106 supports the compression requested. If not, the method resorts to initiating local compression of the medical image 94 after having been received over the communication network 106. But if both the PACS server and the publisher 10 support the desired compression routine, a number or total size of medical images 94 to be compressed can be determined from extracting data from a DICOM header 97, by querying the PACS server 106, or by any other suitable manner. Based on the number and/or size of the medical images 94, a time required for local compression and compression at the PACS server 106 can be estimated based on historical data, knowledge of the time required to conduct the desired compression by the respective publisher 10 and PACS server 106, etc. . . . , and these times compared at step 430 to determine if local compression or compression at the PACS server 106 will require less time to complete. The preferred compression for such a medical image 94 will be selected as the location where the compression of the medical image 94 will result in the shortest overall duration of the publication process at step 440 or step 450.

According to another embodiment, the preferred compression can be selected at step 430 to take place where the compression of the medical image 94 alone will require the least amount of time to complete. If local compression is predicted to be shorter than compression at the PACS server 106, then local compression will be selected at step 440 as the preferred compression. On the contrary, if compression at the PACS server 106 is predicted to take less time than local compression, then compression at the PACS server is to be selected as the preferred compression at step 450. In response to selection of the preferred compression, the medical image 94, at step 460, can be received compressed over the communication network 104, received uncompressed over the communication network 104 to be compressed locally, or received uncompressed over the communication network 104 to be stored on the portable computer-readable medium 12 uncompressed.

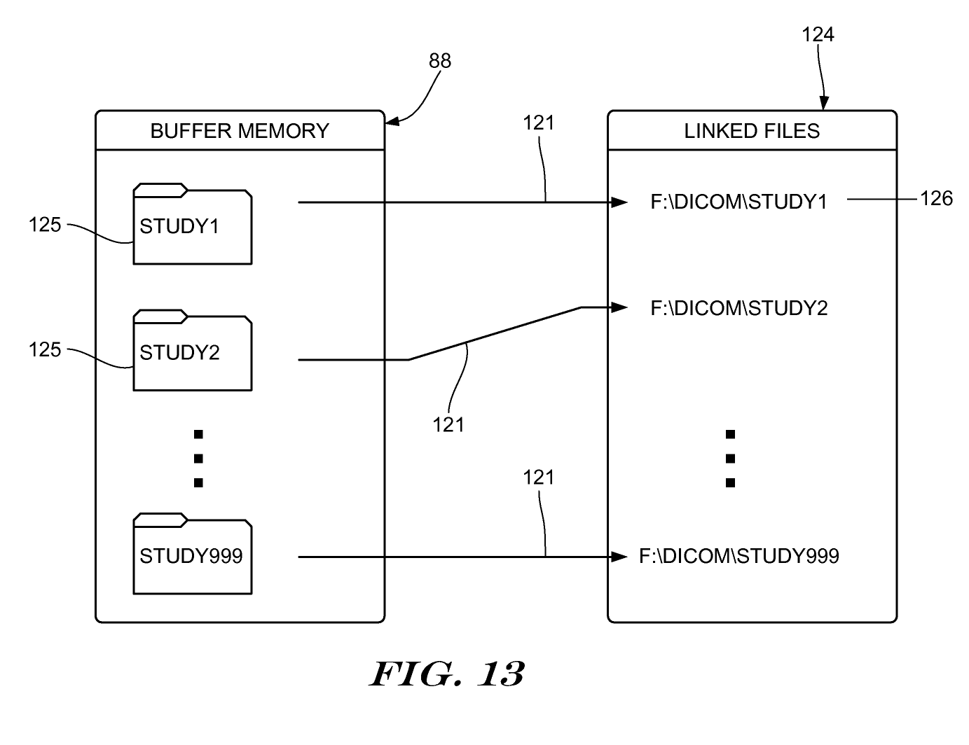

As a medical image 94 is received by the computer-readable medium publisher 10 it is stored, at least temporarily in the buffer memory 88. As shown in FIG. 14 the buffer memory 88 is divided into an array of individual memory locations 140 that each store a portion of the medical image 94. Typically, a predicted allocation C1 of the memory locations 140 is designated by the operating system of the computer-readable media publisher 10 for storing the medical image 94 in the buffer memory 88. If, as shown in FIG. 14, the first allocation C1 includes a greater number of memory locations 140 than required to store the complete medical image 94, a fragment C3a of that allocation C1 is left unused. However, the fragment C3a will not be immediately available for storage of a subsequent medical image 94, so a second allocation C2 is designated for storing a second medical image 94 received. The unused fragment, however, separates the first allocation C1 from the second allocation C2, and a second fragment C3b including the unused memory locations 140 of the second cluster C2 remain.

Subsequent medical images 94 received by the computer-readable media publisher 10 may be broken into blocks equal in size to the unused fragments C3a and C3b, and used to fill in these otherwise unused fragments C3a, C3b. However, the memory locations 140 utilized to store the various medical image files must be recorded. Further, operation of mechanical components of the buffer memory 88, such as rapid repositioning of a mechanical disk head, for example, must be controlled to enable writing/reading to and from separated fragments C3a, C3b storing file portions that collectively form a complete medical image 94. Such record keeping and operation of mechanical buffer memory components is computational-resource intensive, and time consuming, leading to an increase in time to first disc, and reduction of throughput.

An embodiment of the present method and apparatus allows for a preliminary estimation of the medical images 94 to be stored, at least temporarily in the buffer memory 88. According to such an embodiment, the size of the medical image 94 to be received and stored in the buffer memory 88 is predicted in order to request a specific number of memory locations 140 for storing that medical image 94 in the buffer memory 88. Once the size of the medical image 94 has been predicted, an allocation including a contiguous block of memory locations 140 in the buffer memory 88 can be dedicated for storing the medical image 94. The contiguous block of memory locations 140 in the buffer memory 88 that is dedicated is approximately equal in size to the size of the medical image 94 that was predicted.

Referring once again to the top of the buffer memory 88 in FIG. 14, consider the medical images 94 shown stored in allocations C1 and C2, separated by fragment C3a. According to the present embodiment, the size of the first medical image 94 represented by the shaded blocks 141 is predicted, and an allocation C4 of memory locations 140 that is approximately the same size as the first medical image 94 is allocated to store that medical image 94 in the buffer memory 88. A subsequent medical image 94 (represented in the buffer memory 88 of FIG. 14 by shaded memory locations 145) to be received can also have its size predicted, and the allocation C5 of memory locations 140 having approximately the same size dedicated by execution of the computer-executable logic for storing that medical image 94. Thus, fragment C3a between the medical images 94 in the buffer memory 88 can be minimized, or optionally eliminated. While the location of these medical images 94 must still be recorded to be later retrieved, the record keeping is less complicated, and the mechanical writing/reading components of the buffer memory 88 (which can be a hard disk drive, for example) can store/retrieve the medical images 94 in/from the buffer memory 88 in substantially contiguous, unbroken cluster of allocations, with minimal jumping around to many, possibly distant allocations of memory locations 140. Thus, the medical image 94 can be stored substantially continuously in the buffer memory 88 and subsequently continuously retrieved with minimal disruptions to be stored on the portable computer-readable medium 12.

According to one embodiment, the size of the medical image 94 can be predicted based on any data associated with the medical image 94. For example, the size of the medical image 94 can be predicted by evaluating information in the DICOM header 97 portion of the medical image 94. Thus, the allocation to be dedicated in the buffer memory 88 for storing that medical image 94 can be approximately the same size, or optionally slightly larger than the predicted size of the medical image 94.

According to another embodiment, the size of the medical image 94 can be predicted by temporarily storing the medical image 94 in a temporary memory location to determine an actual size of the medical image 94. For other embodiments, the medical image 94 can be stored in a portion of a hard drive or other non-volatile computer-usable memory and simply written over for subsequent operations. Then, the allocation to be dedicated in the buffer memory 88 for storing that medical image 94 can be approximately the same size, or optionally slightly larger than the actually-determined size of the medical image 94. This temporary memory location can optionally be a memory location that is independent of the buffer memory 88, and can be a computer-readable memory module that is separate from the buffer memory 88. For instance, the temporary memory location can be a portion of a hard drive provided to the control unit 28, or within RAM memory 79 of the control unit 28 for example. In addition to these examples, other examples of a suitable computer-usable memory for storing the medical image 94 to determine its size include a portion of the buffer memory 88, an EPROM, a non-volatile magnetic storage medium and a non-volatile solid-state memory module, or any other computer-usable memory operatively connected to communicate with the control unit 28.

For any of the embodiments, the predicted size of the medical image 94 to dedicate a suitably sized allocation can optionally alter a default prediction of the allocation in the buffer memory 88 by an operating system of the portable computer-readable media publisher 10. For example, the predicted size of the medical image 94 can be communicated to the NTFS files system included in certain versions of the Microsoft® Windows® operating system, allowing the operating system to apportion a suitable portion of the buffer memory 88 for storing the medical images 94. Further, predicting the size of the medical image 94 can occur before at least temporarily storing the medical image 94 in the continuous block of the buffer memory 88 dedicated for storing the medical image 94.

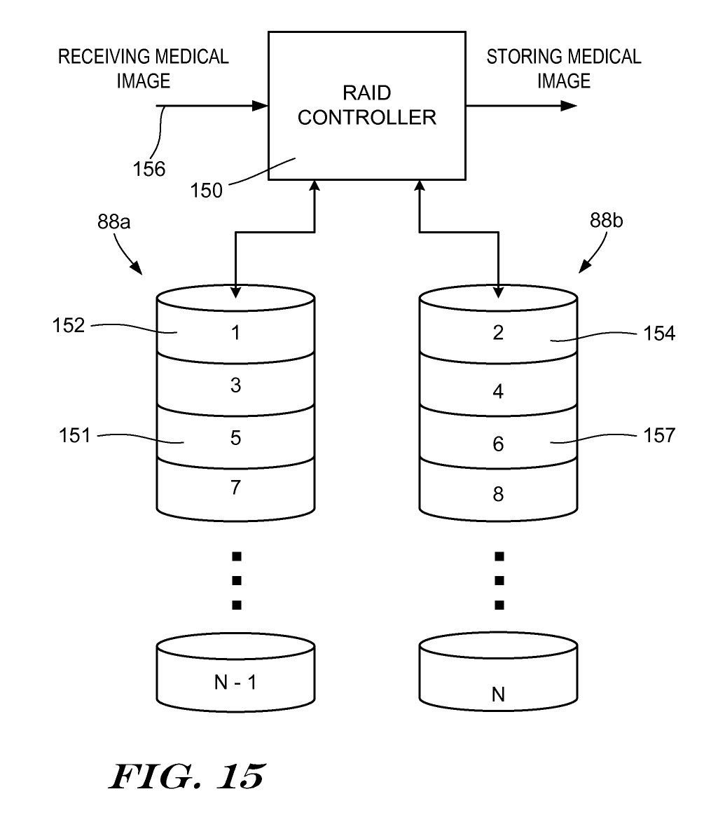

Another embodiment of the method and apparatus expedites publication of a computer-readable medium 12 storing a study comprising at least one medical output produced by a medical modality, the medical output being formatted in a standard medical imaging format that can be opened and observed by users with a computer provided with a compatible viewer or other media presentation software that are configured for viewing medical outputs produced by medical modalities. The method and apparatus includes utilizing a RAID controller 150 for a Redundant Array of Independent Drives/Discs (“RAID”), which is also commonly referred to as a Redundant Array of Inexpensive Drives/Discs and illustrated in FIGS. 6 and 15. Such embodiments also include a plurality of buffer memories 88a, 88b operatively connected to communicate with the computer-readable media publisher 10. For illustrative purposes an embodiment of a RAID controller 150 implemented by software executed by the central processing unit 80 will be described as striping medical images 94 to two buffer memories 88a, 88b is illustrated in FIG. 15 and described herein. Such a RAID configuration is commonly referred to as RAID-0, and can be implemented by a computer hardware component, a computer-executable logic component, or a combination thereof. However, it is to be understood that the present technology can use any desired RAID arrangement, including redundant RAID configurations such as RAID-1 (mirrored buffer memories without parity), and other RAID configurations such as RAID-2 (hamming code parity), RAID-3 (striped set with dedicated parity), RAID-4 (block level striping with dedicated parity), RAID-5 (medical output striping with distributed parity), and RAID-6 (medical output striping across a plurality of memories with dual distributed parity).

According to one embodiment, the RAID controller 150 implements a medical image 94 storage scheme that includes a non-redundant, striped data storage scheme. Each memory block 1-N may be as small as one sector (512 bytes) or as large as multiple gigabytes. The portions of the medical image 94 (also referred to as “stripes”) stored in each memory block are interleaved, so that the overall medical image 94 is collectively formed from the stripes in each buffer memory 88a, 88b. According to such a scheme, the received medical images 94 are logically segmented across the plurality of buffer memories 88a, 88b. With reference to FIG. 15, the segmentation of the medical images 94 includes storing the first portion of the medical image 94 received in the first memory block 152 of the buffer memory 88a. In parallel with the storage of the first received portion of the medical image 94, the RAID controller can break a second portion of the same medical image file into a second packet to be stored in the second memory block 154 in the buffer memory 88b, and so on throughout all N memory blocks. Parallel storage of the first and second portions of the medical image 94 does not require the storage of those two portions at exactly the same time. The second portion of the medical image 94 will likely begin shortly after storage of the first portion has begun. But in this manner, it is not necessary to wait until storage of the first portion of the medical image 94 is complete before storage of the second portion is started. Thus, the time required to fully store the medical image file is less than the time required to store each portion of the medical image 94 in a single buffer memory 88 consecutively in series (i.e., where storage of a first portion must be complete before storage of the second portion begins). Further, the RAID controller 150 can store an incoming medical image 94 introduced to the RAID controller 150 as an input 156 contemporaneously, in parallel with storing the portions of the medical image 94 from the buffer memories 88a, 88b onto the portable computer-readable medium 12, while preventing the occurrence of under-runs in the recording process. The RAID controller 150 can retrieve portions of the medical image 94 that have already been completely stored in the buffer memories 88a, 88b to be recorded onto the portable computer-readable medium 12. Thus, if the RAID controller 150 is storing the medical image 94 in a sixth memory block 157 while contemporaneously storing another portion of the medical image 94 in the fifth memory block 151, the RAID controller 150 can, in parallel with these two operations, transmit the portion of the medical image 94 that was previously stored in the second memory block 154, for example.

As another example, the RAID controller 150 can be a RAID-0 controller, which implements a non-redundant group of striped disk drives. RAID-0 arrays are usually configured with large stripes for I/O intensive applications, but may be sector-striped with synchronized spindle drives for single-user and data intensive environments that access long sequential records. The utilization of a RAID-0 array allows for the contemporaneous performance of two I/O operations.

According to another illustrative embodiment, the first buffer memory 88a can store the computer-executable logic specific to the computer-readable media publisher 10. The computer-executable logic is to be executed by a computer processor for controlling interactions between the various components of the computer-readable media publisher 10 as a unit. The first buffer memory 88a also includes memory blocks for storing, at least temporarily, the first portion of the medical image 94 received from the PACS server 106 to be stored on the portable computer-readable medium. The second buffer memory 88b is accessible independent of the first buffer memory 88a, and includes memory blocks for storing, at least temporarily, the second portion of the medical image 94 received from the PACS server to be stored on the portable computer-readable medium 12. The RAID controller is operable to control storage of the first and second portions of the medical image 94 in parallel in the first and second buffer memories 88a, 88b, along with writing of the first and second portions of the medical image 94 onto the portable computer-readable medium 12. The computer-readable media publisher 10 can optionally include first and second optical recording bays 32 for storing medical image files 12 compliant with the DICOM standard on two separate portable computer-readable media 12 substantially contemporaneously, in parallel. According to yet another embodiment, the computer-readable media publisher 10 can optionally include a third buffer memory (not shown) that is accessible independent of the first and second buffer memories 88a, 88b. The third buffer memory is dedicated as a buffer memory for storing, at least temporarily, a respective medical image 94 to be transmitted to the second recording bay 32 in parallel with transmission of at least a portion of the medical image 94 to the first recording bay 32.

To further minimize the time to first disc and maximize throughput, another embodiment includes rapid selection of a suitable computer-readable medium 12 followed by substantially immediate commencement of storing the medical image file on the portable computer-readable medium 12. A job profile associated with the publication process can be evaluated to identify at least one of: a type of portable computer-readable medium 12 specified in the job profile as the proper portable computer-readable medium to be used, and a format for the label information to be applied within a label region 112 on the portable computer-readable medium 12 that is specified in the job profile. Once this job profile has been evaluated, the suitable computer-readable storage medium 12 can be selected from a storage bin 17. Examples of the format for the label information in the job profile includes at least one of: a speed format including minimal printing requirements to minimize a time required to complete printing the label information within the label region 112, and a standard format that does not significantly restrict the printing requirements, wherein a time required to complete printing of the label information formatted according to the standard format is longer than the time required to complete printing the label information formatted according to the speed format.

The job profile can be locally stored in the buffer memory 88 of the computer-readable media publisher 10. Further, selecting the proper portable computer-readable medium 12 and transporting the portable computer-readable medium 12 to the optical recording bay 32 can be performed in parallel with receiving the transmission according to the DICOM protocol via a communication channel established over the PACS network 104.

Since the publication process can require significant amounts of time to be completed, the computer-readable media publisher 10 is often left unattended during the publication process. If one of a plurality of different portable computer-readable media runs out, or is otherwise unavailable, publication processes in line behind the publication process requiring the unavailable portable computer-readable medium 12 may be unnecessarily delayed, even if they do not require the unavailable portable computer-readable medium 12. To minimize such delays, the present method and apparatus can optionally place the publication process requiring the unavailable portable computer-readable medium 12 in a queue, while allowing other publication processes that don't require the unavailable portable computer-readable medium 12 to proceed.

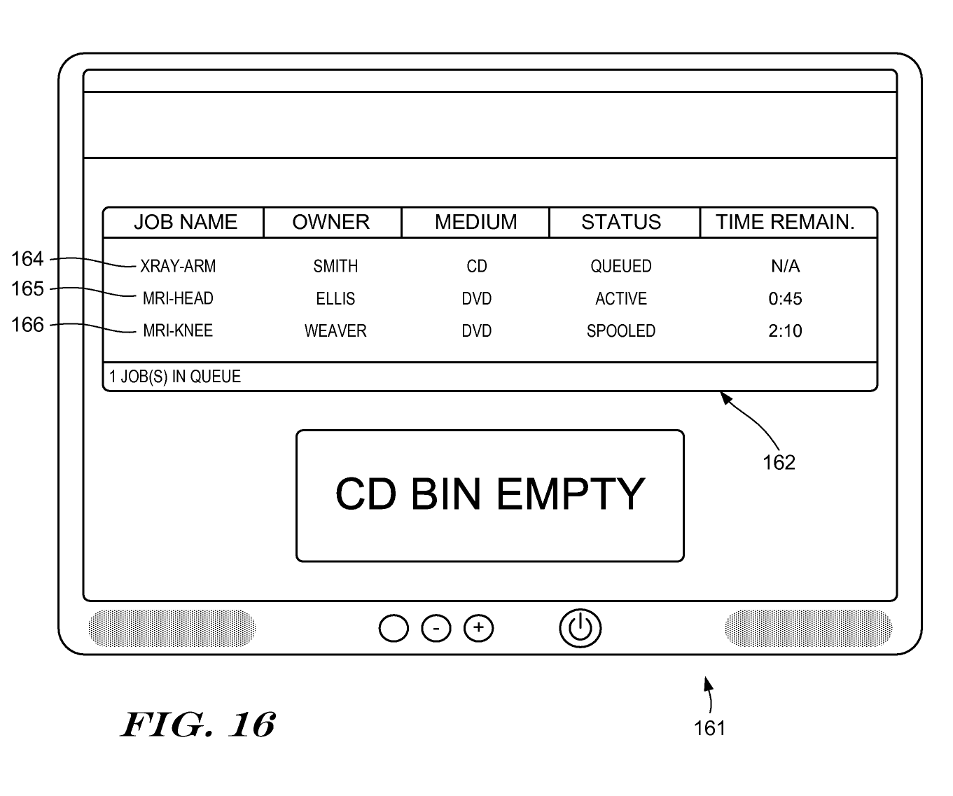

With reference to FIG. 16, a display device 161, such as a LCD monitor for example, displays a publication job summary window 162. Within the job summary window 162 it can be seen that a first publication job 164 was initiated to store X-ray medical images 94 onto a CD. Second and third publication jobs 165, 166 have been initiated for storing MRI-related medical images 94 onto DVDs. A job profile or other data associated with the medical images 94, the publication job, or any other aspect of the publication jobs 164, 165, 166 allow the computer-readable media publisher 10 to identify the type of portable computer-readable medium 12 as being the proper medium for each publication job 164, 165, 166.

In response to identifying the proper medium for each publication job, the computer-readable media publisher 10 selects the proper portable computer-readable medium 12 for the first publication job from among a plurality of portable computer-readable media 12 available to the computer-readable media publisher 10. If, when attempting to select the proper portable computer-readable medium 12 the computer-readable media publisher 10 senses that the proper portable computer-readable medium 12 is unavailable, the computer-readable media publisher 10 is to queue publication of the medical images 94 onto the unavailable portable computer-readable medium until the proper portable computer-readable medium 12 becomes available. The computer-readable medium publisher 10 can continue to record a medical image 94 included in the second publication job 165 onto a different portable computer-readable medium 12 (in this example a DVD) that is available to the computer-readable media publisher at that time while the publication job requiring the CD is queued.

A status report in the form of job summary window 162 prompts the operator of the unavailability of the CD, and that publication of medical images 94 onto the unavailable CDs has been queued. The job summary window also indicates that the publication of medical images 94 onto DVDs will continue uninterrupted while the publication job 164 requiring a CD is queued. The estimated time remaining until completion of the publication jobs requiring DVDs is displayed, but does not take into consideration the delay caused by the queued first publication job 164.

The method disclosed herein can optionally be performed by a processor executing suitable computer-executable instructions. The computer-executable instructions can be stored on a computer-readable medium to be operatively connected with the processor. The computer-executable instructions can optionally be locally stored on a computer-readable memory embedded within a portable computer-readable medium publisher 10 that can execute the computer-executable instructions to carry out the method disclosed herein.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of labeling a computer-readable medium for storing a medical output produced by a medical modality, said medical output being formatted in compliance with a medical output formatting standard, the method comprising:
receiving a transmission comprising the medical output from a host computer over a communication network, wherein a portion of the medical output comprises label information that is to appear in a label region on the portable computer-readable medium, and is received substantially at a beginning portion of the transmission;
storing the medical output as it is received, at least temporarily, in a buffer memory to be subsequently stored onto the portable computer-readable medium;
preparing the label information to appear in the label region from the portion of the medical output comprising the label information; and
applying the label information within the label region on the portable computer-readable medium responsive to preparing the label information, wherein applying the label information within the label region is initiated in parallel with receiving a remaining portion of the transmission comprising the medical output.

2. The method of claim 1, wherein receiving the transmission comprises:
conducting a query of the host computer storing the medical output over the communication network to prepare the label information that is to appear in the label region based on the query conducted over the communication network; and
retrieving the portion of the medical output comprising the label information from the host computer before receiving a remaining portion of the medical output.

3. The method of claim 2, wherein retrieving the label information comprises retrieving label information associated with a plurality of medical outputs to be received and later stored on the portable computer-readable medium before receiving a remaining portion of the medical outputs.

4. The method of claim 1, wherein the medical output is compliant with a DICOM standard and the label information is embedded within the medical output.

5. The method of claim 1, wherein the portable computer-readable medium is an optical computer-readable medium, and wherein applying the label information within the label region comprises printing the label information by applying a printing medium within the label region on an optical computer-readable medium.

6. The method of claim 5, wherein the printing medium is rapid drying, and dries in a period of time, wherein the period of time begins when the printing medium is applied within the label region of the optical computer-readable medium and ends before the optical computer-readable medium is rotated to store the medical output received onto the optical computer-readable medium to resist distortion from being rotated.

7. The method of claim 1 further comprising associating a parameter set with an identifying attribute transmitted over the communication network, wherein the parameter set defines a formatting scheme for the label information to be applied within the label region on the computer-readable medium, wherein the label information is applied within the label region according to the formatting scheme defined by the parameter set.

8. The method of claim 7, wherein the identifying attribute is an application entity title transmitted according to a DICOM standard.

9. The method of claim 8, wherein associating the parameter set with the identifying attribute comprises:
receiving the application entity title according to a DICOM standard from a host computer over a communication network;
associating the application entity title with the parameter set, wherein the parameter set is stored on a local computer-accessible memory; and
formatting the label information according to at least one parameter within the parameter set.

10. The method of claim 1, wherein applying the label information within the label region comprises:
for a second computer-readable medium required to store each medical output to be received, identifying an order of the second computer-readable medium within a collection of computer-readable media.

11. The method of claim 10, wherein the label information comprises at least information to enable a determination of a number of computer-readable media required to store all of the medical outputs to be stored, and the plurality of computer-readable media are labeled to identify an order of the computer-readable media in a sequence.

12. The method of claim 1, wherein the label information is independent of a substance of the medical output to be stored on the computer-readable medium.

13. The method of claim 1, wherein the portable computer-readable medium is an optical computer-readable medium, and preparing the label information to appear in the label region comprises:
creating a layout of the label information that is to appear on the optical computer-readable medium to substantially balance a distribution of a printing medium to be applied to the optical computer-readable medium during application of the label information to minimize an unbalanced condition experienced by the optical computer-readable medium when rotated during storing of the medical output onto the optical computer-readable medium.

14. The method of claim 1, wherein applying the label information within the label region on the portable computer-readable medium is completed before receiving the transmission comprising the medical output is completed.

15. The method of claim 1, wherein the portable computer-readable medium is at least one of: an optical disc, a portable magnetic disc, and a portable flash memory.

16. A method of storing a medical output produced by a medical modality on a portable computer-readable medium, said medical output being formatted in compliance with a medical output formatting standard, the method comprising:
receiving a transmission from a host computer over a communication network, the transmission comprising the medical output that is formatted in the standard medical format;
storing the medical output as it is received, at least temporarily, in a buffer memory operatively connected to a computer-readable medium publisher to be subsequently stored onto the portable computer-readable medium;
establishing a delay between a time when a portion of the medical output is received and a time when the portion of the medical output is stored on the portable computer-readable medium;
subsequent to said delay, storing the portion of the medical output on the portable computer-readable medium in parallel with receiving the transmission from the host computer over the communication network.

17. The method of claim 16, wherein the medical output formatting standard is a DICOM standard, and the medical output is stored on the portable computer-readable medium in the medical output formatting standard.

18. The method of claim 16, wherein the portable computer-readable medium is at least one of: an optical disc, a portable magnetic disc, and a portable flash memory.

19. A method of storing a medical output produced by a medical modality on a portable computer-readable medium, said medical output being formatted in compliance with a medical output formatting standard, the method comprising:
receiving over a communication network a transmission comprising information to be used to establish a communication session over the communication network with a host computer;
responsive to receiving the transmission, transmitting an instruction to the host computer to compress the medical output into a compressed medical output before the medical output is transmitted over the communication network to be stored on the portable computer-readable medium;
receiving the compressed medical output over the communication network;
storing the compressed medical output, at least temporarily, in a buffer memory operatively connected to a computer-readable medium publisher to be subsequently stored onto the portable computer-readable medium; and
subsequent to completion of compression, storing the compressed medical output on the portable computer-readable medium.

20. The method of claim 19, wherein the compressed medical output is stored on the portable computer-readable medium to be uncompressed for subsequent use by a compatible media presentation software being executed by suitable computer hardware.

21. The method of claim 19, wherein said compression is conducted according to a DICOM compliant compression scheme.

22. The method of claim 19, wherein storing the compressed medical output on the portable computer-readable medium requires less time than storing the medical output without previously being compressed on the portable computer-readable medium, wherein a delay incurred by compressing the medical output is less than a difference between a time required to the store medical output uncompressed on the portable computer readable medium and a time required to store the medical output compressed on the portable computer-readable medium.

23. The method of claim 19, wherein the instruction to the host computer to compress the medical output comprises an instruction to compress the medical output according to a predetermined compression scheme.

24. The method of claim 23 further comprising determining that the predetermined compression scheme is supported by the host computer, wherein receiving the compressed medical output over the communication network is responsive to a determination that the predetermined compression scheme is supported by the host computer.

25. The method of claim 19, wherein compression of the medical output is performed according to a DICOM compliant lossless compression scheme.

26. The method of claim 19, wherein transmitting the instruction to the host computer is conducted automatically, without operator intervention.

27. A method of storing a medical output produced by a medical modality on a portable computer-readable medium, said medical output being formatted in compliance with a medical output formatting standard, the method comprising:
receiving over a communication network a transmission comprising information to be used to establish a communication session over the communication network with a host computer;
responsive to receiving the transmission, receiving the medical output in an uncompressed format over the communication network from the host computer;
locally compressing the medical output into a compressed medical output;
storing the medical output, at least temporarily, in a buffer memory to be subsequently stored onto the portable computer-readable medium; and
subsequent to completion of compression, storing the compressed medical output on the portable computer-readable medium, wherein
storing the compressed medical output on the portable computer-readable medium requires less time than storing the medical output uncompressed on the portable computer-readable medium, wherein a delay incurred by locally compressing the medical output is less than a difference between a time required to store the medical output uncompressed on the portable computer readable medium and a time required to store the compressed medical output on the portable computer-readable medium.

28. The method of claim 27, wherein locally compressing the medical output occurs subsequent to receiving the medical output uncompressed over the communication network.

29. The method of claim 27, wherein locally compressing the medical output comprises compressing portions of the medical output as the portions of the medical output are received substantially in real time and storing the portions of the medical output as compressed portions of the medical output, at least temporarily, in the buffer memory.

30. The method of claim 27, wherein the compressed medical output is stored on the portable computer-readable medium to be uncompressed for subsequent use by a compatible media presentation software being executed by suitable computer hardware.

31. The method of claim 27, wherein said compression is conducted according to a DICOM compliant compression scheme.

32. The method of claim 31, wherein compression of the medical output is performed according to a DICOM compliant lossless compression scheme.

33. The method of claim 27, wherein compression of the medical output is conducted automatically, without operator intervention, and locally as the medical output is received over the communication network from the host computer.

34. A method of storing a medical output produced by a medical modality on a portable computer-readable medium, said medical output being formatted in compliance with a medical output formatting standard, the method comprising:
receiving over a communication network a transmission comprising information to be used to establish a communication session over the communication network with a host computer;
predicting that compression of the medical output will shorten a total length of time required to store the medical output on the portable computer readable medium relative to a total length of time required to store the medical output uncompressed on the portable computer-readable medium;
responsive to said predicting that compression of the medical output will shorten the total length of time, predicting whether locally compressing the medical output subsequent to receiving the medical output over the communication network or instructing the host computer to compress the medical output prior to transmission of the medical output over the communication network will be a preferred compression that requires less time to complete;
initiating the preferred compression;
receiving the medical output over the communication network from the host computer;
storing the medical output received over the communication network, at least temporarily, in a local buffer memory location to be subsequently stored on the portable computer-readable medium; and
subsequent to completion of the preferred compression, storing the medical output in a compressed format as a compressed medical output on the portable computer-readable medium.

35. The method of claim 34, wherein the preferred compression is local compression to be conducted subsequent to receiving at least a portion of the medical output over the communication network.

36. The method of claim 34, wherein the preferred compression is local compression to be conducted subsequent to receiving at least a portion of the medical output uncompressed over the communication network, wherein local compression comprises compressing the medical output as it is being received substantially in real time and storing the medical output compressed locally, at least temporarily, in the buffer memory.

37. The method of claim 34, wherein the compressed medical output is stored on the portable computer-readable medium to be uncompressed for subsequent use by a compatible media presentation software being executed by suitable computer hardware.

38. The method of claim 34, wherein said compression is conducted according to a DICOM compliant compression scheme.

39. The method of claim 31, wherein compression of the medical output is performed according to a DICOM compliant lossless compression scheme.

40. The method of claim 34, wherein predicting that compression of the medical output will shorten a total length of time required to store the medical output on the portable computer readable medium comprises:
determining that the medical output is stored uncompressed by the host computer; and
estimating that a size of the compressed medical output will be larger than a minimum amount of data required to be stored on the portable computer-readable medium.

41. The method of claim 34, wherein predicting that instructing the host computer to compress the medical output prior before transmitting the medical output over the communication network will be the preferred compression comprises:
estimating a time required to store a backlog comprising at least one queued job including a medical output received over the communication network and stored in the local buffer memory; and predicting that compression of at least a portion of the medical output will be completed by the host computer before storing the medical output of the at least one queued job from the local buffer memory onto the portable computer-readable medium will be completed.

42. The method of claim 41 further comprising instructing the host computer to compress the medical output into compressed medical output before transmitting the compressed medical output over the communication network.

43. The method of claim 34, wherein predicting whether locally compressing the medical output subsequent to receiving the medical output over the communication network or instructing the host computer to compress the medical output prior to transmission of the medical output over the communication network will be the preferred compression comprises:
determining that the host computer does not support compression of the medical output; and
responsive to said determining, selecting local compression of the medical output as the preferred compression.

44. The method of claim 34, wherein predicting whether locally compressing the medical output subsequent to receiving the medical output over the communication network or instructing the host computer to compress the medical output prior to transmission of the medical output over the communication network will be the preferred compression comprises:
determining an amount of medical output to be received and subsequently stored on the portable computer-readable medium;
based on the amount of medical output to be received and subsequently stored on the portable computer-readable medium, estimating a first time required for compression of the amount of medical output by the host computer and transmission of the amount of medical output compressed over the communication network;
based on the amount of medical output to be received and subsequently stored on the portable computer-readable medium, estimating a second time required for transmission of the amount of medical output uncompressed over the communication network and subsequent local compression of the amount of medical output.

45. The method of claim 44 further comprising:
determining that the first time is greater than the second time; and
selecting as the preferred compression locally compressing the medical output subsequent to receiving the medical output over the communication network.

46. The method of claim 44 further comprising:
determining that the first time is less than the second time; and
selecting as the preferred compression instructing the host computer to compress the medical output prior to transmission of the medical output over the communication network.

47. A method of storing a medical output produced by a medical modality on a portable computer-readable medium, said medical output being formatted in compliance with a medical output formatting standard, the method comprising:
estimating a size of the medical output to be stored, at least temporarily, in a buffer memory and subsequently on the portable computer-readable medium;
allocating a contiguous block of memory locations of the buffer memory for storing the medical output at least temporarily, wherein the contiguous block of memory locations dedicated is approximately equal in size to the size of the medical output that was estimated;
at least temporarily storing the medical output in the contiguous block of memory locations of the buffer memory allocated for storing the medical output before storing the medical output on the portable computer-readable medium;
retrieving the medical output from the contiguous block of memory locations of the buffer memory to be stored onto the portable computer-readable medium; and
storing the medical output on the portable computer-readable medium.

48. The method of claim 47, wherein the medical output is compliant with a DICOM standard, and estimating the size of the medical output comprises evaluating information in a DICOM header portion of the medical output to estimate the size of the medical output.

49. The method of claim 47, wherein estimating the size of the medical output comprises temporarily storing the medical output to be stored on the portable computer-readable medium in a temporary memory location to determine an actual size of the medical output.

50. The method of claim 49, wherein the temporary memory location is a local computer-accessible memory for storing the medical output after having been received over the communication network.

51. The method of claim 50, wherein the temporary memory location is independent of the buffer memory.

52. The method of claim 47, wherein predicting the size of the medical output comprises transmitting a file size request to a host computer over a communication network requesting an actual size of the medical output.

53. The method of claim 47 further comprising overriding a default size of a block of memory locations in the buffer memory allocated by a file system operating on a portable computer-readable medium publisher with the size of the medical output that was estimated.

54. The method of claim 47, wherein said estimating the size of the medical output occurs before at least temporarily storing the medical output in the contiguous block of memory locations of the buffer memory allocated for storing the medical output.

55. The method of claim 47, wherein estimating the size of the medical output comprises determining an actual size of the medical output.

56. A computer-readable medium publisher for storing a medical output produced by a medical modality on a portable computer-readable medium, said medical output being formatted in compliance with a medical output formatting standard, the computer-readable medium publisher comprising:
a recording bay for writing the medical output that is formatted in the standard medical output formatting standard onto the portable computer-readable medium, wherein the medical output comprises at least a first portion and a second portion;
a first buffer memory for storing, at least temporarily, the first portion of the medical output received from a host computer over a communication network to be subsequently stored on the portable computer-readable medium;
a second buffer memory for storing, at least temporarily, the second portion of the medical output received from the host computer over the communication network to be subsequently stored on the portable computer-readable medium, wherein the second buffer memory is accessible independent of the first buffer memory;
a controller operatively connected locally to the computer-readable medium publisher for storing, at least temporarily, the first portion of the medical output in the first buffer memory and the second portion of the medical output in the second buffer memory, wherein
the controller is operable to control reading of the first and second portions of the medical output in parallel from the first and second buffer memories to be stored as the medical output on the portable computer-readable medium.

57. The computer-readable medium publisher of claim 56, wherein the recording bay is an optical recording bay for writing the first and second portions of the medical output onto an optical disc.

58. The computer-readable medium publisher of claim 56 further comprising a second recording bay for writing another medical output that is also formatted in the standard medical output formatting standard onto another portable computer-readable medium, wherein the controller is operable to control reading of the first and second portions of the medical output to be transmitted to the recording bay and to control reading of first and second portions of the another medical output from the first and second buffer memories to be transmitted to the second recording bay.

59. The computer-readable medium publisher of claim 58, wherein reading of the first and second portions of the medical output to be transmitted to the recording bay and reading of the first and second portions of the another medical output to be transmitted to the second recording bay are conducted in parallel.

60. A method of storing a medical output produced by a medical modality on a portable computer-readable medium, said medical output being formatted in compliance with a medical output formatting standard, the method comprising:
receiving identification information from a host computer over a communication network and entering into a communication session with the host computer, wherein the medical output is to be transmitted from the host computer over the communication network and the identification information is received during an early portion of the communication session;
receiving a transmission over the communication network, said transmission comprising the medical output that is formatted in the medical formatting standard;
establishing that the medical output is to be automatically recorded onto the portable computer-readable medium without operator intervention once at least a portion of the medical output has been received;
selecting an appropriate type of the portable computer-readable medium to be used to store the medical output, wherein selecting the appropriate type of the portable computer-readable medium occurs before receiving the transmission comprising the medical output is complete;
responsive to selecting the appropriate type of the portable computer-readable medium, transporting the appropriate type of portable computer-readable medium to a destination as part of a publication process for storing the medical output onto the portable computer-readable medium, wherein transporting the appropriate type of portable computer-readable medium is accomplished automatically, without operator intervention;
locally storing the medical output, at least temporarily, in a buffer memory to be subsequently stored on the appropriate type of portable computer-readable medium; and
storing the medical output from the buffer memory onto the appropriate type of portable computer-readable medium.

61. The method of claim 60, wherein the destination is a recording bay, said method further comprising initializing the recording bay including the appropriate type of portable computer-readable medium in preparation for recording of the medical output onto the appropriate type of portable computer-readable medium.

62. The method of claim 61, wherein initializing the recording bay comprises:
rotation of the portable computer-readable medium in the recording bay; and
recognition of the appropriate type of portable computer-readable medium by a computer-readable media publisher provided with the recording bay before recording of the medical output on the appropriate type of portable computer-readable medium begins.

63. The method of claim 60, wherein transporting the appropriate type of portable computer-readable medium comprises selecting the appropriate type of portable computer-readable medium from among a plurality of available storage bins storing a plurality of different types of available computer readable media, wherein the appropriate type of portable computer-readable medium is selected based on a parameter in a parameter set associated with the identification information.

64. The method of claim 63, wherein the parameter set is locally stored on a computer-readable memory of a computer-readable medium publisher that is operable to store the medical output on the appropriate portable computer-readable medium.

65. The method of claim 64, wherein the identification information comprises an identifying attribute received from the host computer over the communication network that identifies the parameter set locally stored on the computer-readable memory to be used for controlling operation of the computer-readable medium publisher.

66. The method of claim 65, wherein the host computer is a PACS server storing the medical output.

67. The method of claim 65, wherein selecting the appropriate type of the portable computer-readable medium comprises associating the identifying attribute with a locally stored parameter set, wherein the parameter set comprises a parameter indicative of the appropriate type of portable computer-readable medium for storing the medical output.

68. The method of claim 60, wherein selecting the appropriate type of the portable computer-readable medium to be used to store the medical output comprises:
conducting a query of the host computer storing the medical output to retrieve information indicative of a size of the medical output to be received; and
based on the information indicative of the size of the medical output, selecting a suitably large capacity computer-readable medium as the appropriate type of the portable computer-readable medium.

69. The method of claim 60, wherein selecting the appropriate type of the portable computer-readable medium to be used to store the medical output comprises:
receiving information from the host computer directly identifying the appropriate type of portable computer-readable medium without reference to a locally stored parameter set; and
based on the information from the host computer, selecting the portable computer-readable medium specified as the appropriate type of the portable computer-readable medium.

70. The method of claim 60, wherein the appropriate type of portable computer-readable medium comprises at least one of a CD, DVD, Blu-ray Disc and a HD-DVD.

71. The method of claim 60, wherein the appropriate type of portable computer-readable medium includes a flash-based computer-readable memory.

72. The method of claim 60, wherein the appropriate type of portable computer-readable medium is selected based on a parameter in a parameter set associated with the identification information. the parameter being indicative of a value of at least one of:
a required archive life of the portable computer-readable medium for storing the medical output;
a recording speed required for storing the medical output onto the portable computer-readable medium;
a quality of a label to be applied to the portable computer-readable medium; and
a cost of the portable computer-readable medium to be used for storing the medical output.

73. The method of claim 60, wherein the destination is a printer for applying label information within a label region provided to a surface of the appropriate type of portable computer-readable medium.

74. The method of claim 73 further comprising initiating application of the label information in parallel with the receiving of the transmission comprising the medical output over the communication network.

75. A method of performing a job that includes storing a medical output produced by a medical modality on a portable computer-readable medium, said medical output being formatted in compliance with a medical output formatting standard, the method comprising:
receiving a transmission according to a transmission protocol employed in a medical network, said transmission comprising the medical output that is compliant with the medical output formatting standard;
at least temporarily storing the medical output as it is received in a buffer memory to be subsequently stored on a portable computer-readable medium, wherein the portable computer-readable medium is one of a plurality of different portable computer-readable media available to a computer-readable media publisher utilized for storing the medical output on the portable computer-readable medium;
selecting a first portable computer-readable medium as an appropriate portable computer-readable medium to be used to store the first medical output;
responsive to selecting the first portable computer-readable medium as the appropriate portable computer-readable medium, determining an availability of the first portable computer-readable medium from among a plurality of portable computer-readable media available to the computer-readable media publisher for storing medical output;
sensing that the first portable computer-readable medium is unavailable;
responsive to said sensing, queuing the job comprising storing the medical output on the first portable computer-readable medium until the first portable computer-readable medium becomes available to the computer-readable media publisher; and
initiating another job that includes storing another medical output on a second portable computer-readable medium that is available to the computer-readable media publisher while the job is queued.

76. The method of claim 75 further comprising displaying to an operator an indication on a display device indicating that the job comprising storing of the medical output on the first portable computer-readable medium has been queued.

77. The method of claim 75 further comprising predicting an amount of time remaining before completion of the another job comprising storing of the another medical output onto the second portable computer-readable medium is completed.

78. The method of claim 77, wherein predicting the amount of time excludes from consideration a length of time required to complete the job comprising storing the medical output on the first portable computer-readable medium that has been queued.

79. The method of claim 78 further comprising displaying the amount of time remaining before completion of the another job on the display device.

80. A computer readable medium publisher for receiving a medical output produced by a medical modality over a communication network and storing said medical output onto a portable computer readable medium, said medical output being formatted in compliance with a medical output formatting standard, the computer readable medium publisher comprising:
a network interface for communicating with and receiving the medical output from a host computer storing the medical output over the communication network;
a first recording bay for storing the medical output received over the communication network onto the portable computer readable medium;
at least one of: an automated feeder for transporting the portable computer readable medium to the first recording bay, and a printer for applying label information to a label region;
a control unit for controlling transmission of the medical output to the first recording bay to be stored on the portable computer readable medium and operation of the at least one of the automated feeder and the printer;
a first connector extending and establishing communication between the control unit and the first recording bay, wherein the medical output is to be transmitted to the first recording bay by the first connector to be stored on the portable computer readable medium; and
a second connector that is electrically independent of the first connector, said second connector extending and establishing communication between the control unit and the at least one of the automated feeder and the printer for transmitting control signals to the at least one of the automated feeder and the printer.

81. The computer readable medium publisher of claim 80 further comprising:
a second recording bay for storing a different medical output received over the communication network onto a second portable computer readable medium; and
a third connector that is electrically independent of the first and second connectors, said third connector extending and establishing communication between the control unit and the second recording bay, wherein the different medical output is to be transmitted to the second recording bay by the third connector to be stored on the second portable computer readable medium.

82. The computer readable medium publisher of claim 81, wherein each of the first, second and third connectors are electrically independent of each other.

83. The computer readable medium publisher of claim 81, wherein the first, second and third connectors are independently selected from an IEEE 1394 cable, a USB cable, a SATA cable, an eSATA cable, a fibre channel cable, a SCSI cable, and a HDMI cable.

84. The computer readable medium publisher of claim 80, wherein the first connector is dedicated for transmitting the medical output to the first recording bay and the second connector is dedicated for transmitting the control signals.

85. A method of storing a medical output produced by a medical modality on a portable computer-readable medium, the medical output being formatted in compliance with a medical output formatting standard, the method comprising:
communicating with a host computer storing the medical output over a communication network to establish a communication session with the host computer;
receiving a transmission over the communication network, wherein the transmission comprises the medical output formatted in the standard medical output formatting standard;
storing the medical output, at least temporarily, in a buffer memory to be subsequently read from the buffer memory and stored on the portable computer-readable medium;
establishing a referential link between the medical output in the buffer memory and a desired arrangement of the medical output on the portable computer readable medium on which the medical output is to be stored;
referring to the referential link to read the medical output from the buffer memory to be stored on the portable computer-readable medium;
transmitting the medical output read from the buffer memory to a recording bay; and
storing the medical output on the portable computer readable medium according to the referential link.

86. The method of claim 85, wherein the referential link is at least one of a symbolic link and a hard link.

87. The method of claim 85, wherein the medical output is to be stored on the portable computer readable medium as arranged by the referential link without first copying the medical output from the buffer memory to another local computer-accessible memory.

88. The method of claim 85, wherein the referential link specifies at least one of: a name to be given to the medical output read from the buffer memory and stored on the portable computer readable medium; and a folder on the portable computer readable medium in which the medical output is to be stored from the buffer memory.

89. The method of claim 85 further comprising assigning a name to the medical output stored in the buffer memory.

90. The method of claim 89 further comprising storing the medical output in a folder within the buffer memory, wherein the referential link is established between the folder in the buffer memory and a desired arrangement of the folder on the portable computer readable medium on which the folder comprising the medical output is to be stored.

91. The method of claim 89 further comprising providing the medical output with a permanent name on the portable computer-readable medium, wherein the referential link associates the permanent name to the name of the medical output stored in the buffer memory.

92. The method of claim 85 further comprising generating a file specifying an arrangement of the medical output on the portable computer-readable medium relative to other contents saved on the portable computer-readable medium.

93. The method of claim 92, wherein the file is updated in real time to specify the arrangement of the medical output on the portable computer-readable medium in response to establishment of the referential link between the medical output in the buffer memory and the arrangement of the medical output on the portable computer-readable medium.

94. The method of claim 93 further comprising storing, at least temporarily, a plurality of medical outputs in the buffer memory; and creating an individual referential link between each of the plurality of medical outputs in the buffer memory and an arrangement of the plurality of medical outputs to be stored on the portable computer-readable medium, wherein the file is generated after each of the individual links is established.

95. The method of claim 92, wherein the file is to be stored at a root level of the portable computer-readable medium and the medical output is to be stored within a folder located at the root level of the portable computer-readable medium.

96. A method of publishing a portable computer-readable medium for storing a medical output produced by a medical modality, said medical output being formatted in compliance with a medical output formatting standard, the method comprising:
receiving an identifying attribute from a host computer over a communication network and entering into a communication session with the host computer;
associating a parameter set with the identifying attribute, wherein the parameter set comprises a parameter that defines an operational function of a portable computer-readable medium publisher for storing the medical output onto the portable computer-readable medium to minimize a length of time required to complete publication of the portable computer-readable medium;
receiving a transmission over the communication network, said transmission comprising the medical output to be stored on the portable computer-readable medium;
locally storing the medical output, at least temporarily, in a buffer memory to be subsequently stored on the portable computer-readable medium; and
storing the medical output from the buffer memory on the portable computer-readable medium.

97. The method of claim 96, wherein the parameter set is stored locally to be compared with the identifying attribute received over the communication network.

98. The method of claim 96, wherein the parameter defines a maximum amount of medical output to be stored on the portable computer-readable medium, wherein the maximum amount of medical output comprises a single collection of related medical images.

99. The method of claim 96, wherein the parameter defines a type of portable computer-readable medium for storing the medical output.

100. The method of claim 99, wherein the type of portable computer-readable medium defined by the parameter comprises a storing speed allowing the medical output to be stored quicker on the portable computer-readable medium defined by the parameter than on another type of portable computer-readable medium available to the portable computer-readable medium publisher.

101. The method of claim 96, wherein parameter defines that storing the medical output from the buffer memory on the portable computer-readable medium is to be initiated in response to a termination of the communication session after the medical output has been received and stored, at least temporarily, in the buffer memory.

102. The method of claim 101, wherein initiation of the storing of the medical output on the portable computer-readable medium occurs without waiting for expiration of a predetermined period of time to indicate that the medical output has been received.

103. The method of claim 96 further comprising applying label information within a label region of a label, wherein the parameter defines at least one of:
a print quality setting that that minimizes a length of time required to apply the label information within the label region;
a limit of graphical label information to be applied within the label region; and
a maximum number of printing media colors to be used for applying the label information within the label region.

104. The method of claim 103, wherein the limit of graphical label information prevents graphical label content from being applied within the label region.

105. The method of claim 103, wherein the maximum number of printing media colors is one.

106. The method of claim 96, wherein the identifying attribute is an application entity title transmitted from a computer-accessible storage device storing a database of medical output from a medical modality over the communication network according to a DICOM standard.
